(19) United States
(12) Patent Application Publication
(10) Pub. No.: US 2018/0203122 A1
(43) Pub. Date: Jul. 19, 2018

(54) GATED STRUCTURED IMAGING

(71) Applicant: BRIGHTWAY VISION LTD., Haifa (IL)

(72) Inventors: Yoav GRAUER, Haifa (IL); Ofer DAVID, Haifa (IL); Eyal LEVI, Haifa (IL)

(73) Assignee: BRIGHTWAY VISION LTD., Haifa (IL)

(21) Appl. No.: 15/744,805

(22) PCT Filed: Jul. 14, 2016
(86) PCT No.: PCT/IL2016/050770

§ 371 Date: Jan. 14, 2018

(30) Foreign Application Priority Data
Jul. 14, 2015 (IL) 239919

(51) Int. Cl. G01S 17/89; G01S 17/10; G01S 17/93

(52) U.S. Cl. CPC G01S 17/89; G01S 7/4863; G01S 17/936; G01S 17/107

(57) ABSTRACT

Methods and systems are provided, which illuminate a scene with pulsed patterned light having one or more spatial patterns; detect reflections of the pulsed patterned light from one or more depth ranges in the scene, by activating a detector for detecting the reflections only after respective traveling times of the illumination pulses, which correspond to the depth ranges, have elapsed; and derive an image of the scene from the detected reflections and according to the spatial patterns. The methods and systems integrate gated imaging and structured light synergistically to provide required images which are differentiated with respect to object ranges in the scene and different patterns applied with respect to the objects and their ranges.

### BACKGROUND OF THE INVENTION

### 1. Technical Field

The present invention relates to the field of imaging, and more particularly, to combining gated imaging and structured light methods synergistically and to providing a range map from objects.

### 2. Discussion of Related Art

WIPO Publication No. 2015/004213, which is incorporated herein by reference in its entirety, discloses a system for detecting the profile of an object, which comprises a radiation source for generating a radiation pattern, a detector which has a plurality of pixels and a processor for processing data from the detector when radiation from the radiation source is reflected by an object and detected by the detector. The system also comprises a synchronization means interfacing between the detector and the radiation source. The radiation source is designed for operating in pulsed mode and the synchronization means can synchronize the pulses of the radiation source with the sampling of the detector.

U.S. Patent Publication No. 20130222551, which is incorporated herein by reference in its entirety, discloses a method for video capturing that illuminates a stationary outdoor scene containing objects, with a structured light exhibiting a specified pattern, at a first angle; captures reflections from the objects in the stationary scene, in a second angle, the reflections exhibiting distortions of the specified pattern; and analyzes the reflected distortions of the specified pattern, to yield a three dimensional model of the stationary scene containing the objects, wherein the specified pattern may include temporal and spatial modulation.

U.S. Pat. No. 8,194,126, which is incorporated herein by reference in its entirety, discloses a method of gated imaging. Light source pulse (in free space) is defined as:

$${T}_{LASER} = 2 ( \frac{{R}_{0} - {R}_{MIN}}{c} ) ,$$

wherein the parameters are defined below. Gated camera ON time (in free space) is defined as:

$${T}_{II} = 2 ( \frac{{R}_{MAX} - {R}_{MIN}}{c} ) .$$

Gated camera OFF time (in free space) is defined as:

$${T}_{OFF} = 2 \frac{{R}_{MIN}}{c} ,$$

where c is the speed of light, R₀, R_{MIN} and R_{MAX} are specific ranges. The gated imaging is utilized to create a sensitivity as a function of range through time synchronization of T_{LASER}, T_{II} and T_{OFF}.

Hereinafter a single “Gate” (i.e., at least a single light source pulse illumination followed by at least a single camera/sensor exposure per a single readout) utilizes a specific T_{LASER}, T_{II} and T_{OFF} timing as defined above. Hereinafter “Gating”/“Gating parameters” (i.e. at least a single sequences of; a single light source pulse illumination followed by a single camera/sensor exposure and a single light source pulse illumination followed by a single camera/sensor exposure ending the sequence a single image readout) utilizes each sequence a specific T_{LASER}, T_{II} and T_{OFF} timing as defined above.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a method comprising: (i) illuminating a scene with pulsed patterned light having at least one specified spatial pattern, (ii) detecting reflections of the pulsed patterned light from at least one specified range in the scene, by activating a detector for detecting the reflections only after at least one traveling time of the respective illumination pulse, corresponding to the at least one specified range, has elapsed, and (iii) deriving an image of at least a part of the scene within the at least one specified range, from the detected reflections and according to the at least one spatial pattern.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram of a system for imaging a scene, according to some embodiments of the invention.

FIG. 2A is a high level flowchart illustrating optional uses of the system, according to some embodiments of the invention.

FIG. 2B is a high level schematic block diagram illustrating synergistic effects of structured light and gated imaging employed by the system, according to some embodiments of the invention.

FIG. 3A is a high level schematic illustration of a part of the illuminator, according to some embodiments of the invention.

FIG. 3B schematically illustrates pattern changes at different depth ranges, according to some embodiments of the invention.

FIGS. 4A and 4B schematically illustrate pattern adaptations, according to some embodiments of the invention.

FIGS. 5A-5H schematically illustrate various patterns, according to some embodiments of the invention.

FIG. 6 is an exemplary illustration of images derived by the system, according to some embodiments of the invention.

FIGS. 7A and 7B are high level schematic illustrations of the scene with applied adaptive virtual fences, according to some embodiments of the invention.

FIGS. 8A and 8B are high level schematic illustrations of the detector, according to some embodiments of the invention.

FIGS. 9A and 9B schematically illustrate related temporal sequences of illumination and detection parameters, according to some embodiments of the invention.

FIGS. 10A-10D schematically illustrate handling the pixel array of the detector, according to some embodiments of the invention.

FIG. 11 is a high level flowchart illustrating a method, according to some embodiments of the invention.

FIGS. 12A-12D are high level schematic block diagrams of systems configurations, according to some embodiments of the invention.

FIGS. 13A and 13B are high level schematic illustrations of measuring vehicle distances, according to some embodiments of the invention.

### DETAILED DESCRIPTION OF THE INVENTION

Prior to the detailed description being set forth, it may be helpful to set forth definitions of certain terms that will be used hereinafter.

The terms “structured light” or “patterned illumination” as used in this application refer to the use of projected spatial designs of radiation on a scene and geometrically deriving from reflections thereof three dimensional (3D) characteristics of the scene. It is noted that illumination may be in infrared (any of different wavelength ranges) and/or in the visible range.

The terms “depth” or “depth range” as used in this application refer to distances between scene segments and illuminators and/or detectors. The terms “depth” or “depth range” may relate to a single distance, a range of distances and/or weighted distances or distance ranges in case illuminator(s) and detector(s) are spatially separated. The term “traveling time” as used in this application refers to the time it takes an illumination pulse to travel from an illumination source to a certain distance (depth, or depth range) and back to the detector (see more details below).

The term “gated imaging” as used in this application refers to analyzing reflections of scene illumination according to the radiation's traveling time from the illuminator to the scene and back to the detector, and relating the analyzed reflections to the corresponding depth ranges in the scene from which they were reflected. In particular, the detector does not collect any information while the pulse of light is projected but only after the traveling time has passed. A single image readout from the detector (sensor) includes one or more single image sensor exposure(s), each corresponding to a different traveling time.

The terms “integration” and “accumulation” as used in this application, are corresponding terms that are used interchangeably and to the collection of the output signal over the duration of one or more time intervals.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Methods and systems are provided, which illuminate a scene with pulsed patterned light having one or more spatial patterns; detect reflections of the pulsed patterned light from one or more depth ranges in the scene, by activating a detector for detecting the reflections only after respective traveling times of the illumination pulses, which correspond to the depth ranges, have elapsed; and derive an image of the scene from the detected reflections and according to the spatial patterns. The methods and systems integrate gated imaging and structured light synergistically to provide required images which are differentiated with respect to object ranges in the scene and different patterns applied with respect to the objects and their ranges. Methods and systems may be optionally configured to provide images of the scene, to operate in daytime and/or in nighttime, to operate in inclement weather (rain, snow, smog, dust, etc.) and/or to operate from static and from moving platforms.

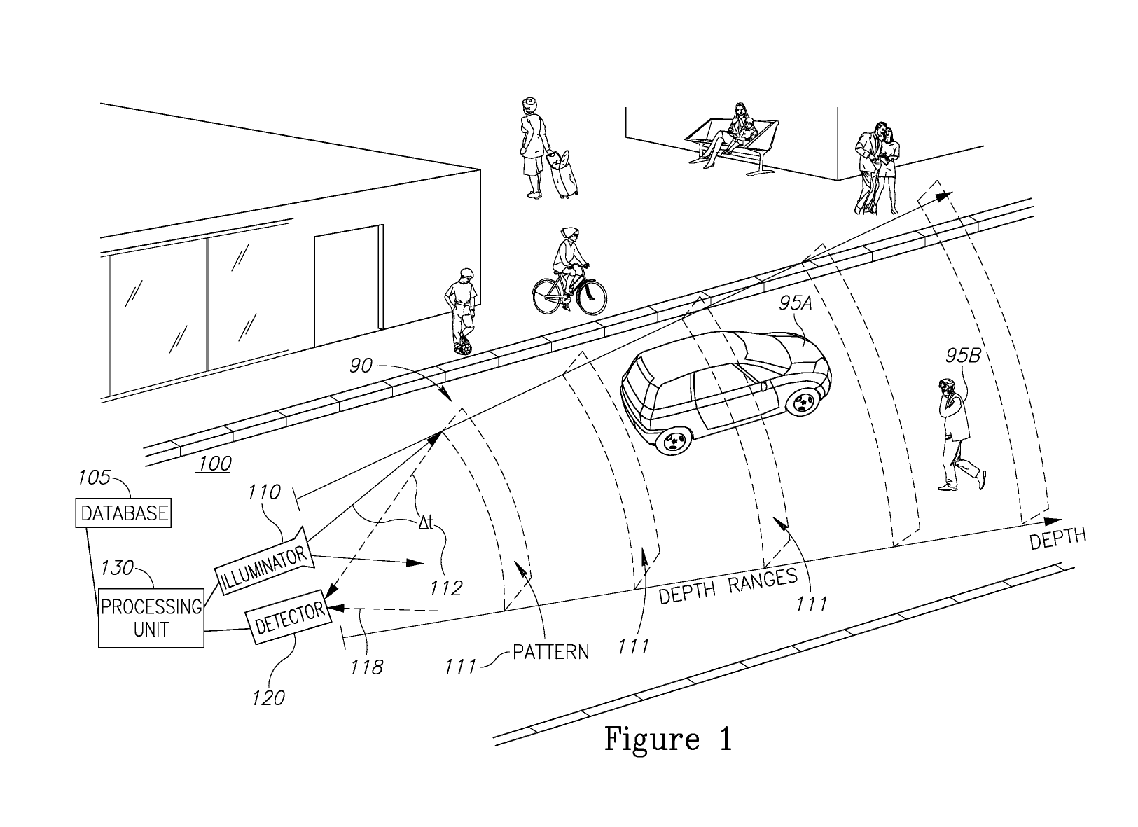

FIG. 1 is a high level schematic block diagram of a system 100 for imaging a scene 90, according to some embodiments of the invention. System 100 comprise an illuminator 110 configured to illuminate scene 90 with pulsed patterned light having a specified spatial pattern 111 (shown schematically in FIG. 1), a detector 120 configured to detect reflections 118 from scene 90 of the pulsed patterned light, and a processing unit 130 configured to derive an image of at least a part of scene 90 within a specified range, from detected reflected patterned light pulses having a traveling time 112 that corresponds to the specified range (e.g.,

$${T}_{OFF} ≡ Δ t = \frac{2 dn}{c}$$

with d the range and c the speed of light, n the index of refraction of an optical medium or

$$[ {T}_{OFF} = \frac{2 {d}_{1} n}{c} ] \leq Δ t \leq [ \frac{2 {d}_{2} n}{c} \approx min ( {T}_{LASER} , {T}_{II} ) ]$$

for the span of traveling time between ranges d₁ and d₂) and according to spatial pattern 111. It is noted that different patterns may be detected from different ranges, both due to spatial expansion of the pattern with range and possibly due to different illuminated patterns detected at different ranges, as explained in more detail below. Illumination and detection may be multispectral (i.e., the gated imaging may be applied in a multispectral manner). In certain embodiments, system 100 may further comprise a database 105 that relates patterns to objects, with processing unit 130 further arranged to select, using database 105, the illumination pattern according to objects identified in the derived image and control illuminator 110 accordingly. Database 105 may comprise different objects, their characteristics (e.g., forms, reflectivity parameters) as well as correlations between objects and patterns, such as selected patterns for different objects and expected object signals for different patterns. Processing unit 130 may use database 105 to actively analyze the scene by searching for or verifying specific objects according to the expected signals for the illuminated patterns and by illuminating the scene with patterns corresponding to existing or expected objects, in relation to database 105.

System 100 may be associated with any type of vehicle, such as vehicles moving on roads, in air, on and in water etc. System 100 may be attached to a vehicle, mounted on a vehicle or integrated in a vehicle. System 100 may be associated with the vehicle at one or more locations, e.g., any of its front, back, sides, as well as top and down surfaces (e.g., for airborne or underwater vehicles). System 100 may interact (e.g., via a communication module) with external sources of information providing e.g., maps and information regarding traffic signs and traffic light, as well as with vehicle internal sources of information providing system 100 vehicle-related information such as speed, the angle of the axles, its acceleration, temporal information and so forth.

In certain embodiments, system 100 may comprise illuminator 110 configured to illuminate scene 90 with pulsed patterned light having at least one specified spatial pattern, detector 120 configured to detect reflections from the scene of the pulsed patterned light, and processing unit 130 configured to derive three dimensional (3D) data of at least a part of scene 90 within a plurality of ranges, from detected reflected patterned light pulses having traveling times that correspond to the specified ranges and according to the at least one spatial pattern. The 3D data may correspond to data requirements of an autonomous vehicle on which system 100 is mounted. The 3D data may be derived by system 100 as sole output or in addition to image(s) of the scene. For example, the 3D data may comprise a cloud of points, each with depths or distances provided by system 100. System 100 may be configured to provide varying resolution of the points in the clouds, depending on the patterns used. System 100 may be configured to provide as 3D data a grid of distances which may be classified to detected objects. Certain object minimal dimensions may be defined and provided to system 100 as minimal object size detection threshold, according to which pattern parameters may be adapted.

Detector 120 may have a mosaic spectral pattern array (e.g., a two by two or any other number of repeating sub pixels that are repeated over the pixelated array of imaging sensor 120), which is constructed and operates in accordance with some embodiments of the present invention. The spectral pattern array may have a visible and NIR spectral response that provides a signal of illumination pattern 111 and also provides a signal due to ambient light.

The illumination and detection are illustrated schematically in FIG. 1 by respective arrows and the depth of scene 90 is indicated by an axis, with specified ranges marked thereupon. It is noted that the specified range denotes a section of scene 90 along the depth axis, which may have defined starting depth and end depth. The travelling time of an illumination pulse may be calculated geometrically—for a non-limiting radial case as 2 r/c (r being the range and c being the speed of light in air, neglecting the index of refraction of the optical medium) so that for detecting reflected illumination from a specified range between r₁ and r₂, reflected illumination detected between 2 r₁/c and 2 r₂/c after the respective illumination pulse is used to provide the respective image part (such synchronization between the illumination source and the detection means is referred to as gated imaging). For example, the specified range may be defined to include objects 95A and/or 95B in scene 90.

In certain embodiments, illuminator 110 may be configured to illuminate scene 90 with pulsed patterned light having a specified spatial pattern 111 in a forwards direction, a backward direction, a rotating mode or in an envelope of a full hemisphere (360°, 2π), of half a hemisphere (180°, π), or of any other angular range around system 100. The spatial extent of the illumination may be modified according to varying conditions.

In certain embodiments, processing unit 130 may be further configured to calculate the traveling time geometrically with respect to the specified range. Processing unit 130 may be further configured to control detector 120 and trigger or synchronize detector 120 for detecting the reflection only after the traveling time has elapsed from the respective illumination pulse.

Processing unit 130 may be configured to operate within one or more wavelength ranges, e.g., bands in infrared and/or visible ranges, provide correlations between image parts or data in different ranges and possibly enhance images and/or data using these correlations.

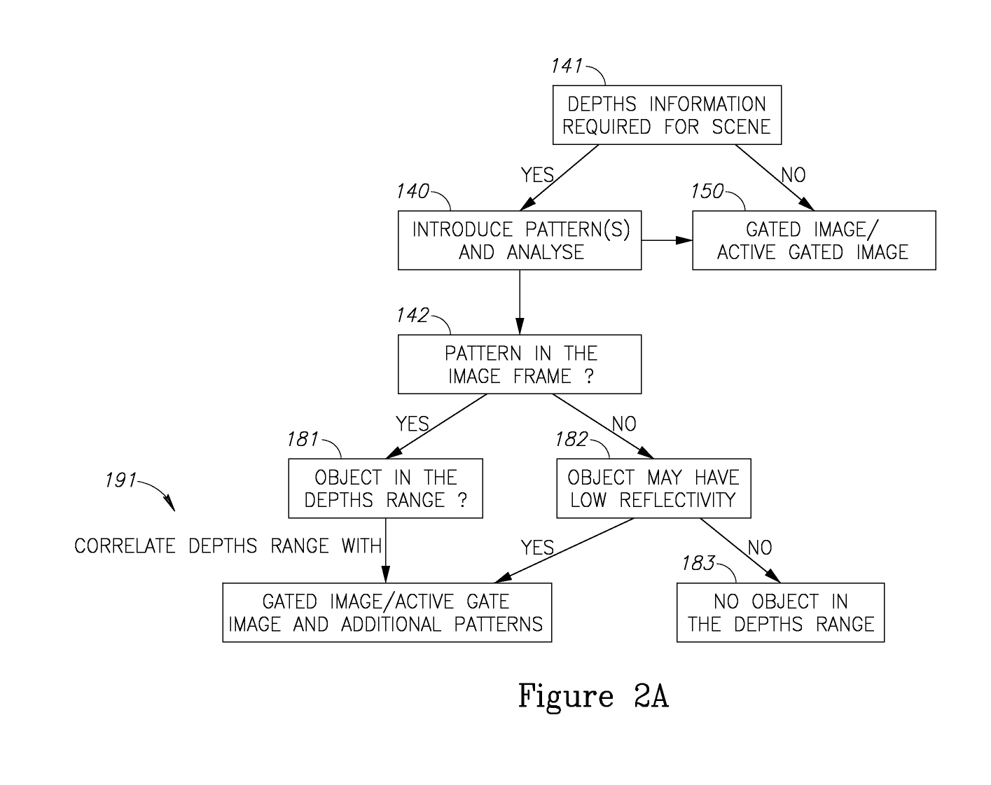

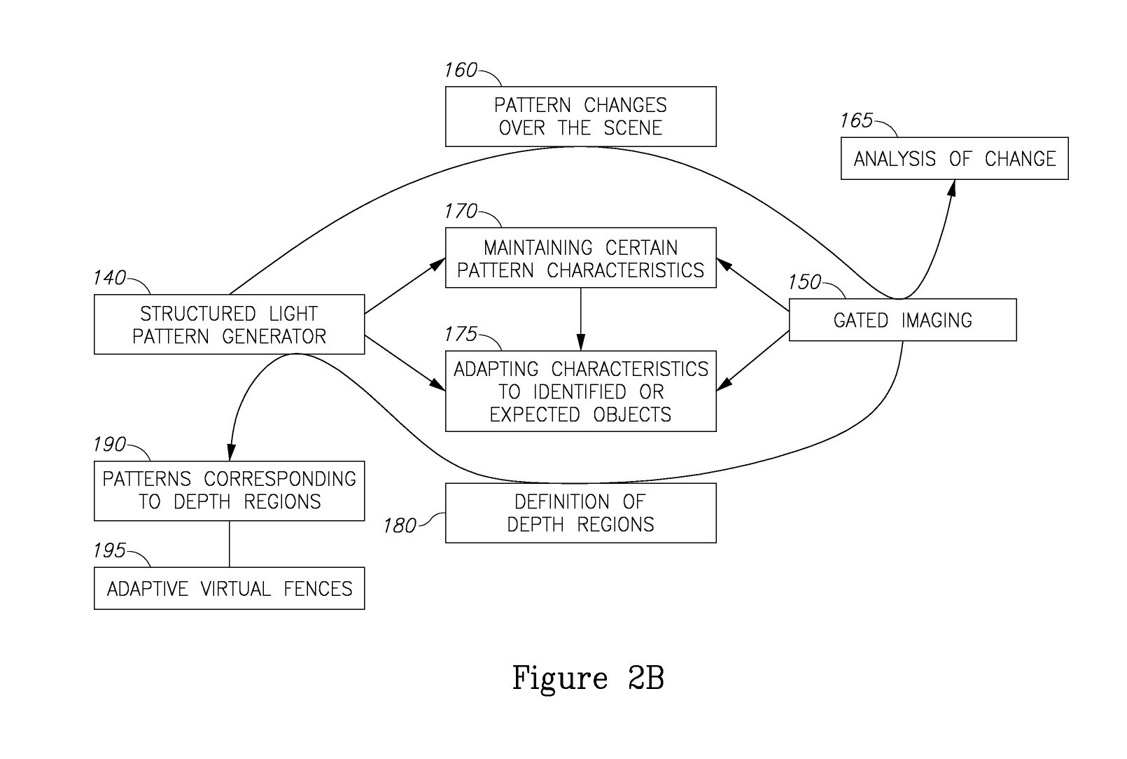

FIG. 2A is a high level flowchart illustrating optional uses of system 100, according to some embodiments of the invention. When depth information is required for the scene (141), corresponding patterns may be introduced and analyzed (140) and gated imaging may be applied (150) for the depth analysis (gated imaging may be applied also when no depth information is required, e.g., to exclude background noise). When the patterns are detected in the image frame (142), objects are detected in the depth range (181) and depth ranges may be correlated with any of the gated image(s) and patterns (191). In case pattern(s) are not identified in the frame, corrections may be made for the possibility that the object has a low reflectivity (182), e.g., by enhancing detector sensitivity or modifying the pattern and/or gating parameters; and if the corrections do not yield objects in the depth range, it may be concluded that no object is the depth range(s) (183).

System 100 synergistically combines structured light and gated imaging technologies to yield reciprocal enhancement of the yielded images and data. FIG. 2B is a high level schematic block diagram illustrating synergistic effects of structured light and gated imaging employed by system 100, according to some embodiments of the invention. FIG. 2B schematically illustrates direct combinations of structured light and gated imaging (middle section) as well as complementary use of gated imaging to enhance structured light approach (upper section) and complementary use of structured light approach to enhance gated imaging (lower section). Using structured light is represented by structured light pattern generator 140 which may be part of processing unit 130 (or of illuminator 110), while using gated imaging is represented by corresponding element 150 which may be implemented by the control of detector 120 with respect to illuminator 110 by processing unit 130 or in detector 120 itself. The arrows denote various combinations of structured light 140 and gated imaging 150, according to some embodiments of the invention. Such combinations illustrated in FIG. 2B are specified and exemplified below.

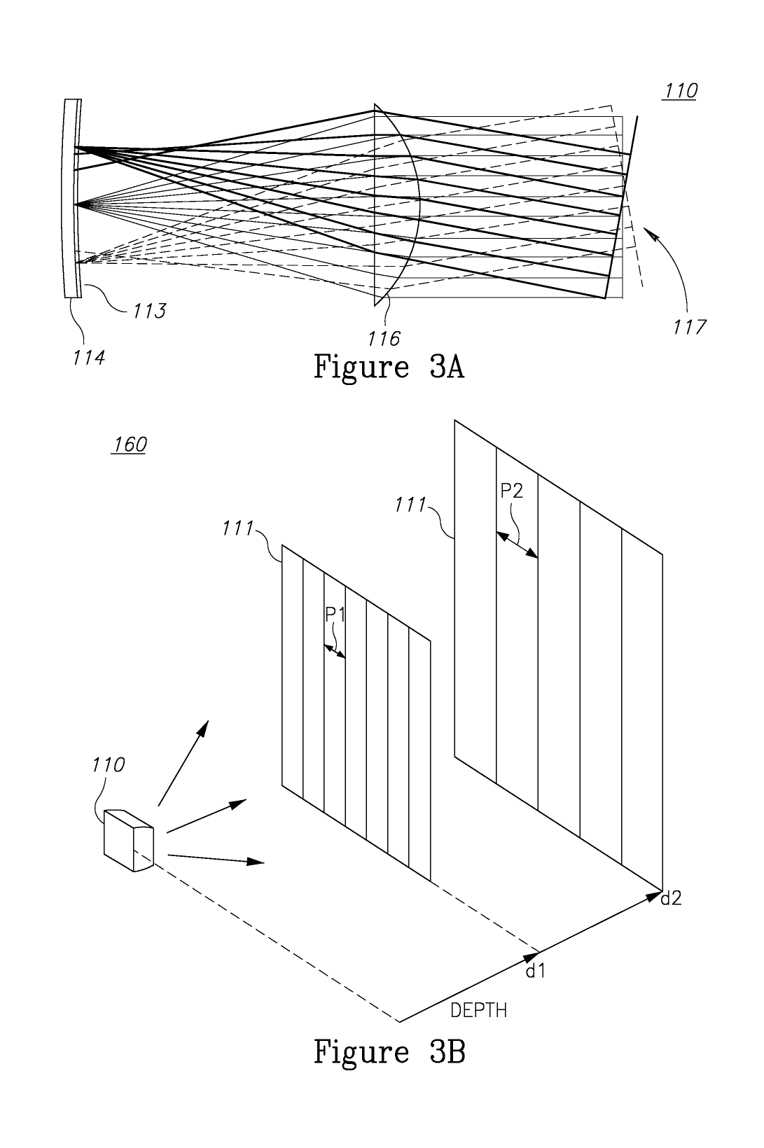

FIG. 3A is a high level schematic illustration of a part of illuminator 110, according to some embodiments of the invention. Illuminator 110 may comprise an array of emitters 113 as part of a die 114 which may be straight, uneven or curved. Illuminator 110 may comprise optical element(s) 116 (e.g. lens(es), prism(s) and/or beam splitter(s)) that in coordination with the form of die 114 yield specific patterns at specific directions 117. Die 114 may be formed to yield illumination along specified direction(s) 117 and optical element(s) 116 may be controlled and move along the optical axis to enlarge, shape, focus or defocus patterns 111. Illuminator 110 may be configured to provide illumination patterns as well as illumination for gated imaging at different rates. It is noted that illuminator 110 may be implemented using any kind of light source, in any wavelength range. Array of emitters 113 may comprise a homogenous distribution of emitters or a non-homogeneous distribution of emitters comprising some areas with a higher density of emitters and other areas with a lower density of emitters.

Illuminator 110 may be embodied as a semiconductor light source (e.g., a laser). Possible semiconductor light sources may comprise at least one vertical-cavity surface-emitting laser (VCSEL) (e.g., a single emitter or an array of emitters), at least one edge-emitting laser (e.g., a single emitter or an array of emitters), at least one quantum dot laser, at least one array of light-emitting diodes (herein abbreviated LEDs) and the like. Illuminator 110 may have one central wavelength or a plurality of central wavelengths. Illuminator 110 may have a narrow spectrum or a wide spectrum. Illuminator 110 may also be embodied as an intense pulsed light (herein abbreviated IPL) source. Illuminator 110 may comprise multiple types of light sources; one type of light source for active gated imaging (e.g., VCSEL technology) and another type of light source for pattern 111 (e.g., edge emitter).

Referring to FIG. 2B, as patterns illuminated on the scene by structured illumination 140 change geometrically over the scene (160), these changes may be detected and analyzed with respect to depth ranges in the scene by gated imaging 150 to provide an analysis of the pattern changes (165) at different ranges and corresponding to different objects. FIG. 3B schematically illustrates pattern changes at different depth ranges, according to some embodiments of the invention. An illuminated pattern 111 expands spatially with the distance from illuminator 110 (e.g., the pattern's pitch increases from p₁ to p₂ upon illuminating objects at ranged d₁ and d₂ respectively) and is reflected differently from objects at these ranges. Processing unit 130 may be further configured to derive the image under consideration of a spatial expansion of the pattern at the specified range. In certain embodiments, processing unit 130 may be configured to compensate for reduced spot uniformity or enhance spot uniformity with increasing range. In certain embodiments, patterns may be generated to maintain certain pattern characteristics 170 at different distances from illuminator 110 and thus normalize the image for depth using gated imaging 150. For example, returning to FIG. 3B, illuminator 110 may additionally produce a denser pattern (not illustrated) which has a pitch p₁ at distance d₂.

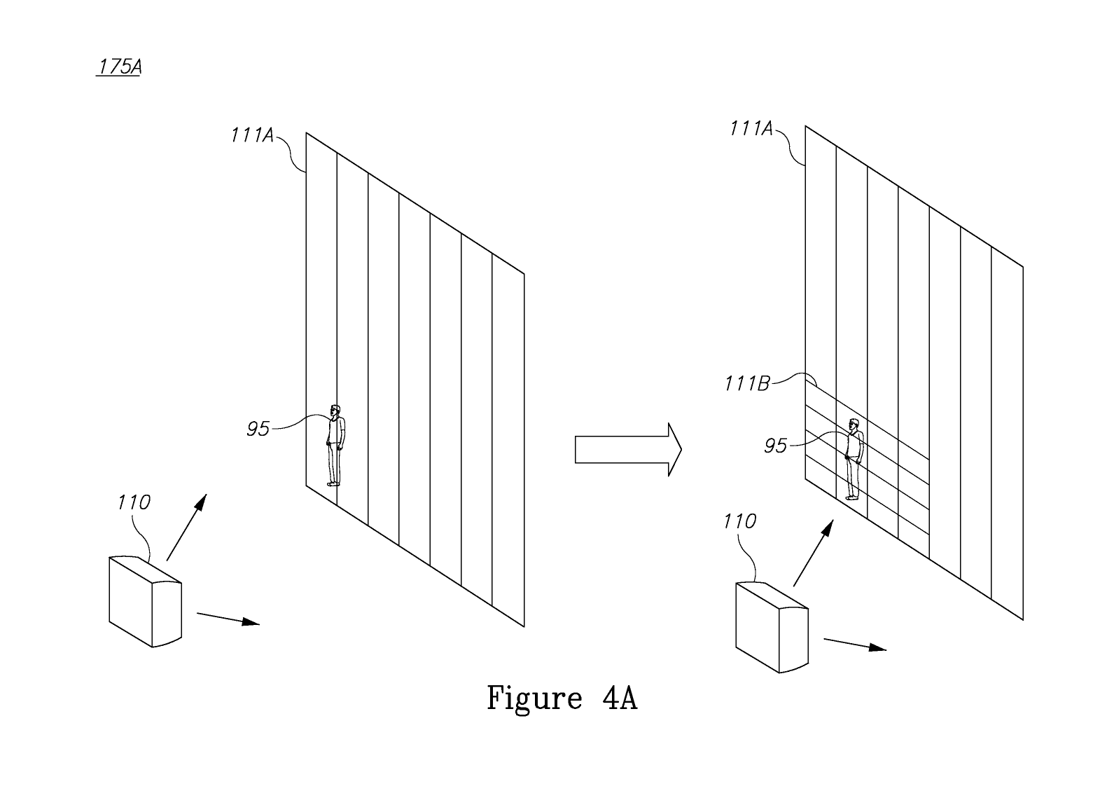

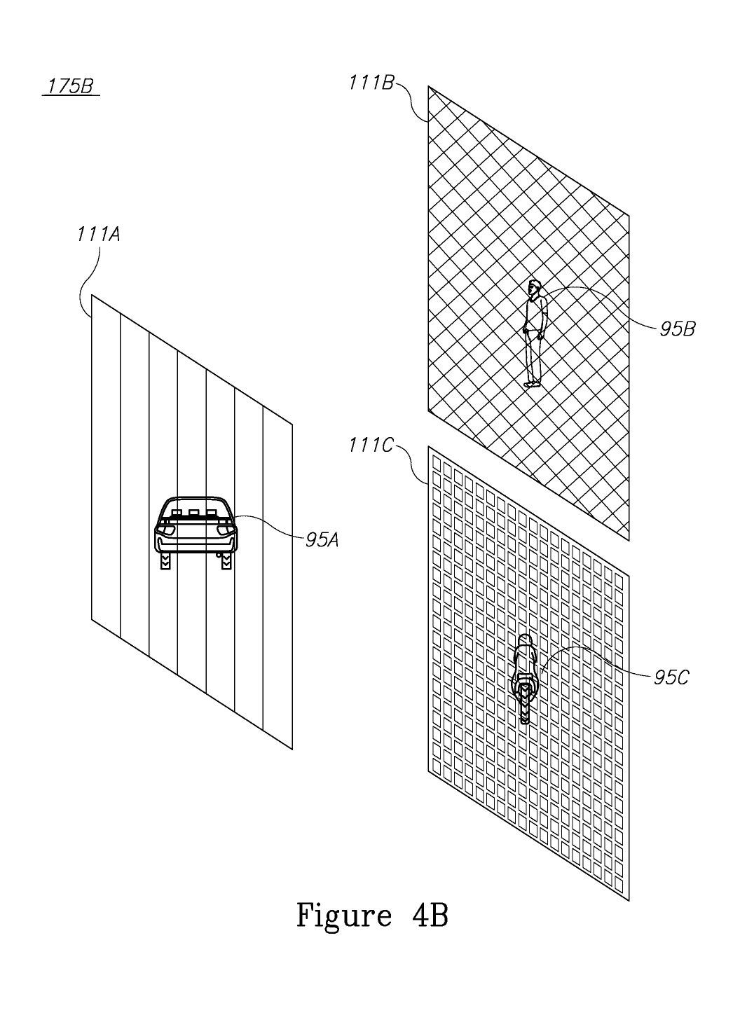

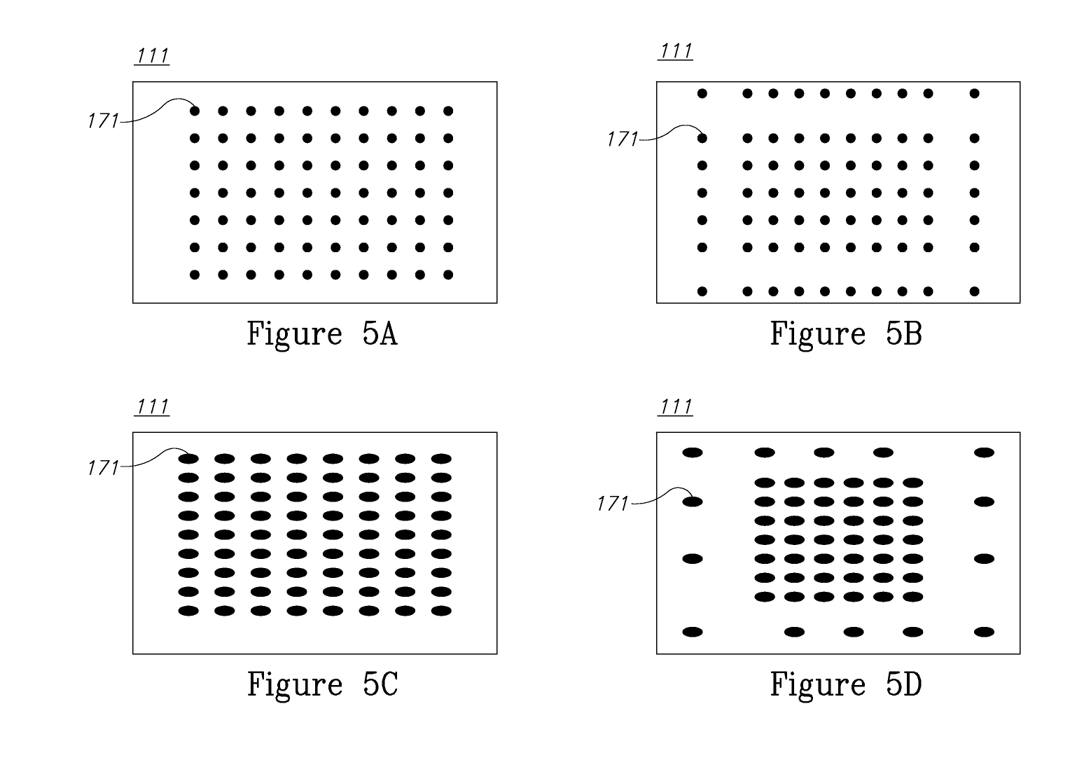

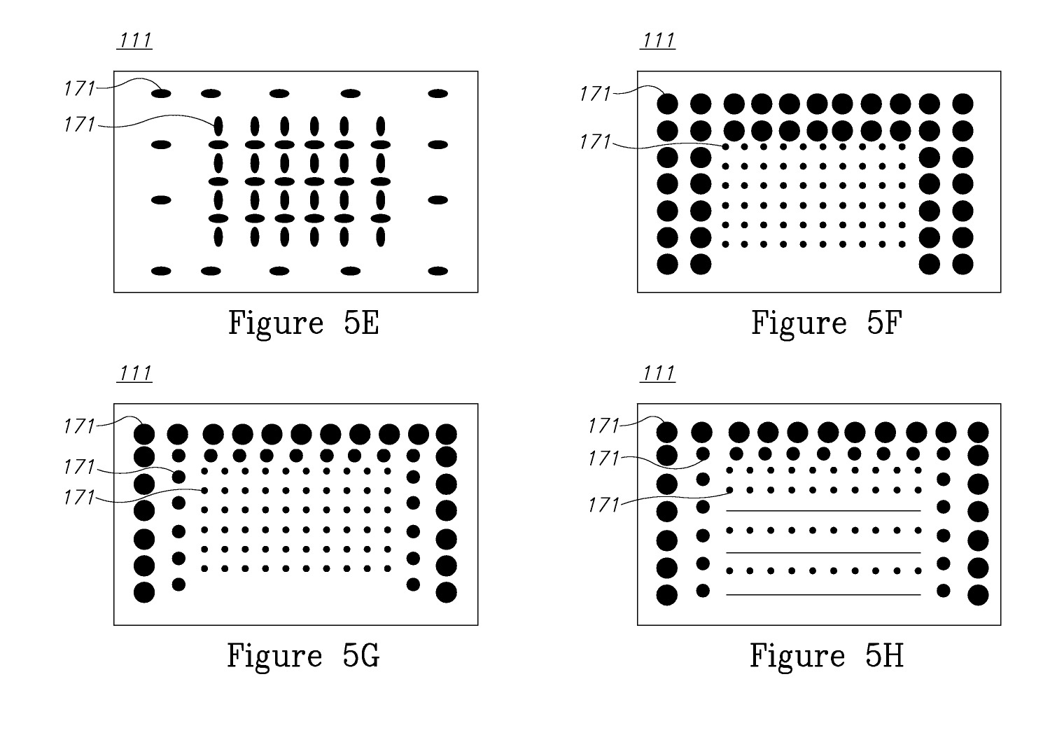

Referring to FIG. 2B, in certain embodiments, pattern characteristics may be adapted to identified or expected objects (175). FIGS. 4A and 4B schematically illustrate pattern adaptations according to some embodiments of the invention. FIGS. 5A-5H below present additional pattern configurations. In certain embodiments, adaptations 175 may be carried out with respect to the depth of the objects. For example, FIG. 4A schematically illustrates pattern 111B which is added to or adapted from pattern 111A to enable better characterization of object 95 at a specified range. In the illustrated non-limiting case, adaptation 175A comprises additional perpendicular pattern elements to improve coverage of object 95 at the specified range. In certain embodiments, adaptations 175 may be carried out with respect to the depth of the objects. For example, FIG. 4B schematically illustrates patterns 111A, 111B, 111C which are adapted according to identified types of objects 95A, 95B and 95C respectively. In the illustrated non-limiting case, adaptation 175B comprises different pattern elements, and/or different pattern characteristics to improve coverage of corresponding objects 95A, 95B and 95C. Processing unit 130 may be further configured to control the pattern illuminated by illuminator 110.

In certain embodiments, illuminator 110 may be configured to illuminate scene 90 with a plurality of patterns 111, each pattern 111 selected by processing unit 130 according to imaging requirements at respective specified ranges. Processing unit 130 may be further configured to adjust at least one consequent pulse pattern according to the derived image from at least one precedent pulse and with respect to parameters of objects 95 detected in the derived image. Processing unit 130 may be arranged to configure the illuminated pattern according to the specified range.

In certain embodiments, different patterns 111 may be at least partially spatially complementary in order to accumulate image information from different regions in the scene illuminated by the different patterns. In certain embodiments, complementary patterns 111 may be employed when system 100 is static. In certain embodiments, when using a single pattern, the motion of system 100 may effectively provide complementary illumination patterns resulting from the motion of the illuminated pattern.

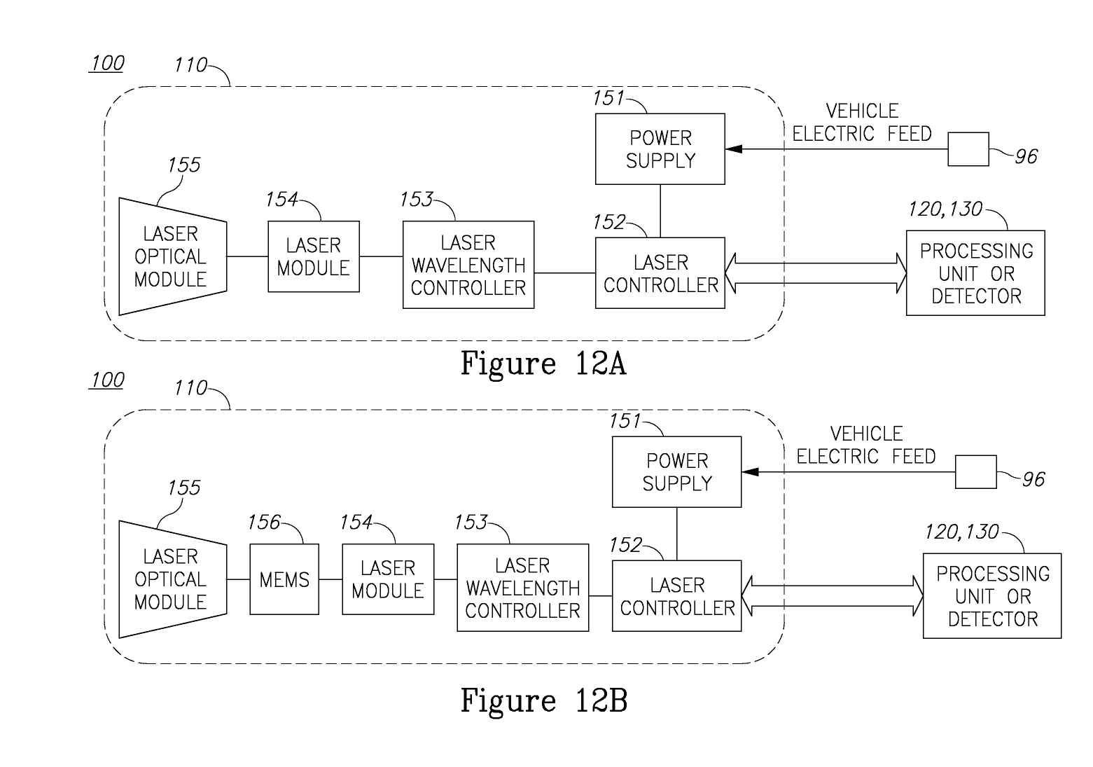

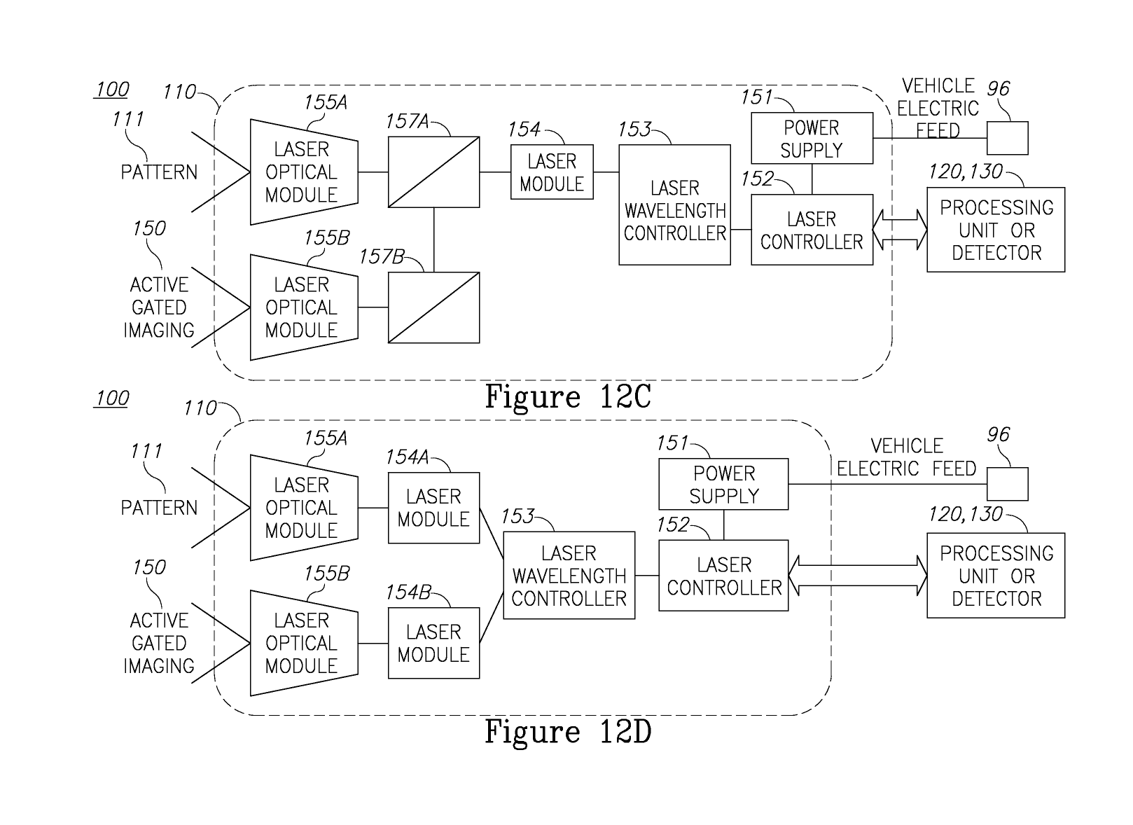

In certain embodiments, pattern changes may be implemented by changing a clustering of illumination emitting area in illuminator 110 (e.g., when using addressable emitters and/or emitter clusters within LED or Laser illuminator 110), or by changing an electro-optical element and/or a mechanical element applied in illuminator 110. In certain embodiments, illuminator 110 may be configured to move or scan at least one pattern across a specified section of scene 90, e.g., move a line pattern type stepwise across the scene section to yield a pattern having multiple lines (see e.g., FIG. 12B below).

FIGS. 5A-5H schematically illustrate various patterns 111, according to some embodiments of the invention. Specific patterns 111 may be selected according with respect to various parameters such as illumination conditions, gating parameters, scene parameters, expected and/or detected objects in the scene, predefined criteria (e.g., virtual fences) etc. FIGS. 5A-5H are non-limiting, and merely demonstrate the diversity of applicant patterns 111. FIG. 5A schematically illustrates a uniform pattern 111 of similar, round dots 171 as elements 171 in pattern 111. FIG. 5B schematically illustrates a non-uniform pattern 111 of similar, round dots 171, in which the density of dots 171 changes across pattern 111, e.g., fewer dots 171 are present at the periphery of pattern 111 and/or regions without dots 171 are part of pattern 111. For example, regions of pattern 111, in which more important objects are expected, may present a higher density of dots 171 in pattern 111. FIG. 5C schematically illustrates a uniform pattern 111 of similar, elliptic dots 171—the form of dots 171 may be shaped according to expected objects of detection, scene characteristics etc. FIG. 5D schematically illustrates a non-uniform pattern 111 of similar, elliptic dots 171, in which the density of dots 171 changes across pattern 111, e.g., fewer dots 171 are present at the periphery of pattern 111 and/or regions without dots 171 are part of pattern 111. It is noted that different dot distributions and/or shapes may be used in different directions (e.g., x and y perpendicular directions, radial and tangential directions, etc.). FIG. 5E schematically illustrates a non-uniform pattern 111 of different, elliptic dots 171, in which both the density and the shape of dots 171 change across pattern 111, e.g., fewer dots 171 are present at the periphery of pattern 111 and/or regions without dots 171 are part of pattern 111, as well as the shape of the dots varying within pattern 111, in the illustrated case dot orientation is partially modified in the center of pattern 111. FIGS. 5F and 5G schematically illustrate non-uniform patterns 111 of different, round dots 171, in which both the density and the shape of dots 171 change across pattern 111, e.g., smaller dots 171 are located in the center of pattern 111 while larger dots 171 are located at the periphery of pattern 111, in the illustrated case only at the top and sides of the pattern's periphery. The size, density and shape of dots 171 may be modified to provide required resolution across different regions of pattern 111. FIG. 5F schematically illustrates two dot sizes while FIG. 5G schematically illustrates a gradual change in dot size towards the periphery of pattern 111. Finally, FIG. 5H schematically illustrates a combination of different dot sizes and lines as elements 171 in pattern 111. Any design of pattern 111, comprising differently shaped elements 171 may be used, possibly multiple different patterns may be projected on different regions of the scene. It is emphasized that FIGS. 5A-5H merely provides exemplary pattern designs and do not exhaust the range of possible patterns applicable in the present invention.

In certain embodiments, pattern 111 may exhibit various symmetries, e.g., reflection symmetry with respect to a specified line and/or a specified point in pattern 111. In certain embodiments, pattern 111 may be projected in a collimated manner to maintain the size of elements 171 at different depths in the scene. In certain embodiments, pattern 111 may a multitude of elements 171 characterized by a coded distribution, e.g., in a speckle pattern.

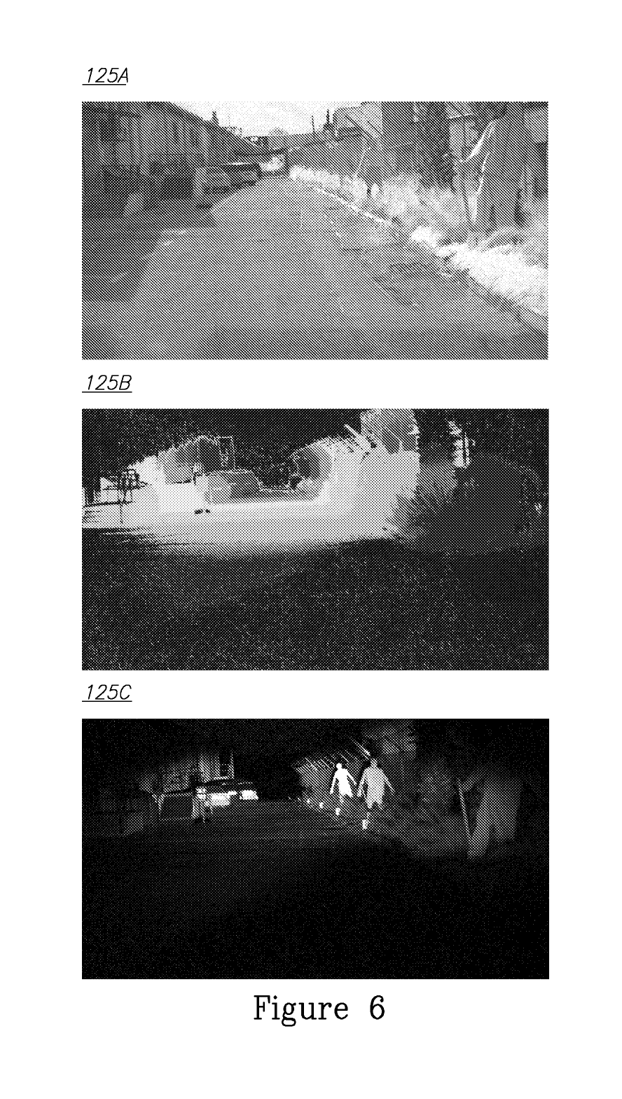

FIG. 6 is an exemplary illustration of images 125A-125C derived by system 100, according to some embodiments of the invention. FIG. 6 illustrates a daytime scene with system 100 located on a static vehicle. The scene consists of three objects (“pedestrians”) on the right side (using laminated wood with clothing), every few meters there are retro-reflectors on the ground (right-side), and on the left side are parked vehicles. Images 125A-125C were taken with the same detector 120 (gated CMOS image sensor). Image 125A is a regular daytime image of scene 90, without using illuminator 110 to illuminate the scene. Illumination patterns 111 used in image 125B are multiple, each having a narrow depth of field (DOF) of about 20 m and image 125B is a depth map, visually illustrating in gray scale the different depth ranges from which the image is composed. At each depth range different patterns may be allocated, or pattern behavior at the specific ranges may be analyzed. Furthermore, patterns may be used to enhance depth estimation within the depth range (according to the detected reflections) and patterns may be selected with reference to objects detected at each depth range. Processing unit 130 may be further configured to subtract a passively sensed image from the derived image. Image 125A may be subtracted from the derived image (using gated structured light) or any other image to remove or attenuate background noise and enhance depth related information, as demonstrated in derived image 125C, being in this case a gated image as the pattern used is a narrow DOF, in which objects are very clearly distinguished from their surroundings. Image 125A may have a similar exposure time or a different exposure time with respect to the exposure time of images 125B or 125C. Image 125A may be generated by a single exposure event per an image readout or by multiple exposures per an image readout. In the illustrated case, image 125A is subtracted from both images 125B, 125C. This approach may be applied at nighttime as well, e.g., to reduce the ambient light. Typically, background image reduction may improve the signal to background ratio in daytime and the signal to noise ratio in nighttime. It is noted that the subtraction or attenuation may be applied to part(s) of the image as well as to the whole image.

In certain embodiments, processing unit 130 may be arranged to derive the image by accumulating scene parts having different specified ranges. In certain embodiments, processing unit 130 is further configured to remove image parts corresponding to a background part of scene 90 beyond a threshold range. Deriving images, image parts defined by depth ranges may be selected according to their relevance, as defined by corresponding rules. Processing unit 130 may use different types of image frames for feature extraction.

In certain embodiments, system 100 may be used for Advanced Driver Assistance Systems (ADAS) features such as: Lane Departure Warning (LDW), Lane Keeping Assist (LKA), Adaptive Headlamp Control (AHC), Traffic Sign Recognition (TSR), Drowsy Driver Detection (DDD), Full Adaptive Cruise Control (ACC), Front Collision Warning (FCW), Automatic Emergency Braking (AEB), ACC Stop & Go (ACC S&G), Pedestrian Detection (PD), Scene Interpretation (SI), Construction Zone Assist (CZD), Road Preview-Speed bump, and pot holes detection (RP), Night Vision Performance (NV), animal detection and obstacle detection. In certain embodiments, system 100 may be used for auto-pilot features or autonomous vehicles. Processing unit 130 may be configured to provide alerts concerning detected situations or conditions, e.g., certain dangers or, in case of autonomous vehicles, of underperformance of vehicle sensing systems.

Referring to FIG. 2B, structured illumination 140 may implement pattern changes over the scene 160 which may be analyzed with respect to depth ranges in the scene by gated imaging 150 to provide an analysis of different patterns at different ranges. In certain embodiments, gated imaging 150 may be used to define depth regions 180 in scene 90 and structured light generator 140 may be used to define patterns that correspond to the defined depth regions 190 to enhance imaging (e.g., provide more details on certain defined regions or less details on other defined regions). Using gated imaging 150 adaptive virtual fences 195 may be applied by generator 140, i.e., the illuminated patterns may be adapted and spatially defined to provide images or imaging data for controlling movement through specified regions. For example, in an automotive context, adaptive virtual fences 195 may be set at regions from which objects are expected (e.g., at cross roads, or between parking cars) to enhance monitoring these regions and provide early alarms.

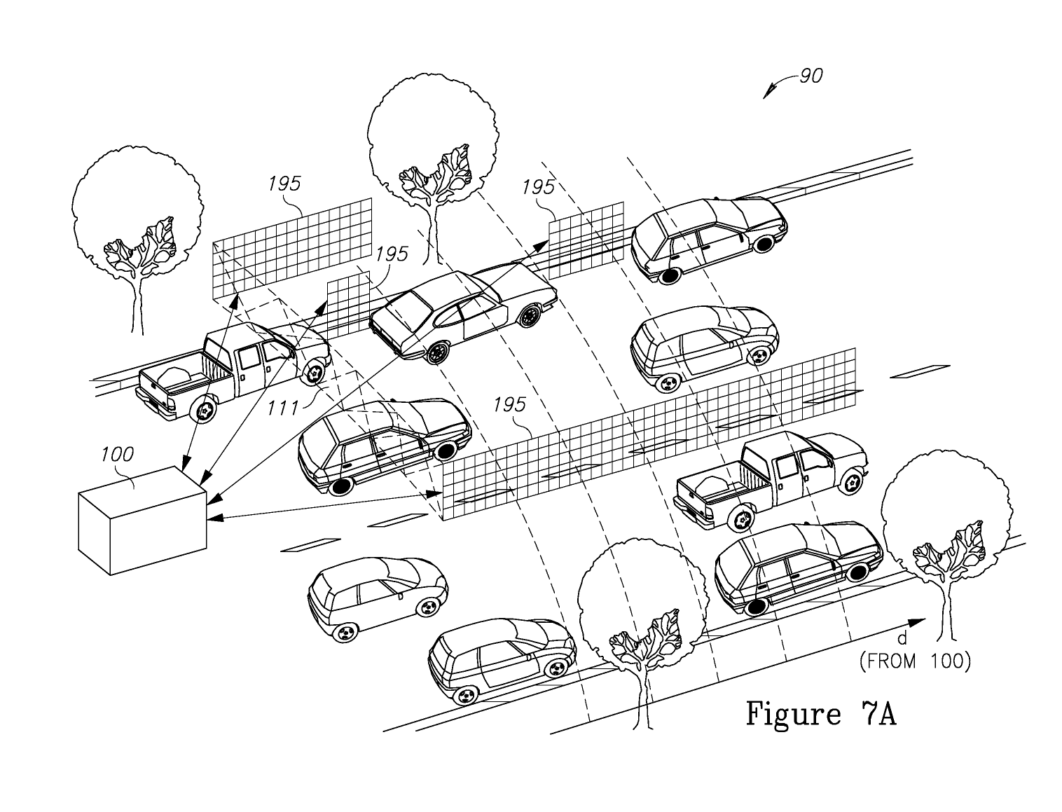

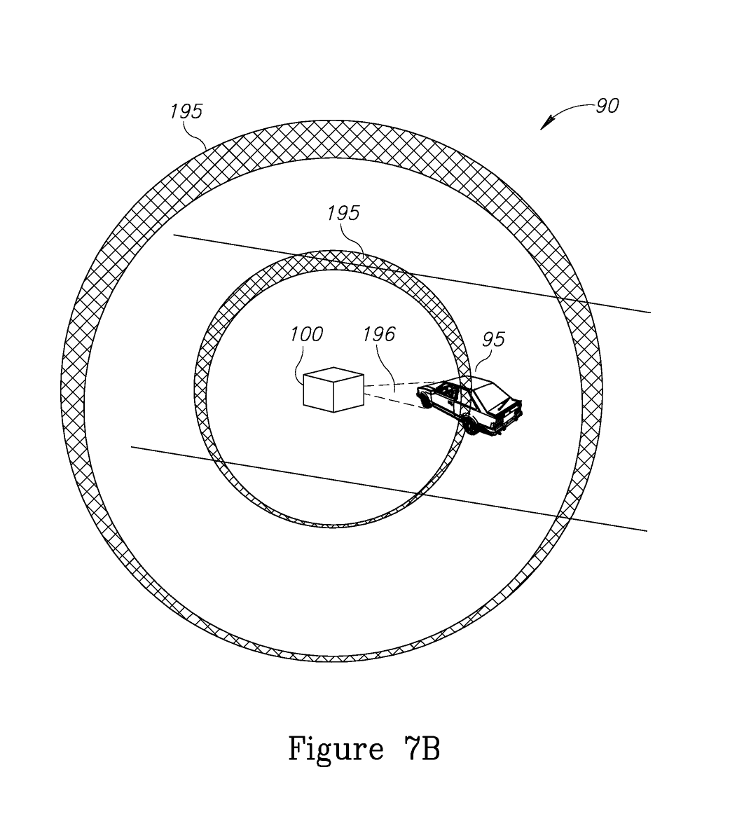

FIGS. 7A and 7B are high level schematic illustrations of scene 90 with applied adaptive virtual fences 195, according to some embodiments of the invention. Virtual fences 195 may be defined using one or more combinations of pattern 111 and range to enable reference to specifically defined two or three dimensional region which is, e.g., as in FIG. 7A, delimited between the respective ranges and possibly by specific illuminated pattern characteristics and possibly additional cues (e.g., objects detected in the image); or, e.g., as in FIG. 7B, encloses system 100, mounted e.g., on an autonomous vehicle. In the non-limiting example of FIG. 7A, virtual fences 195 may be set between trees and along the center line to detect and provide warnings concerning objects, e.g., crossing objects. In the non-limiting example of FIG. 7B, one or more circumferential virtual fences 195 may be projected to surround the vehicle with system 100, and intrusions through virtual fence 195 may be monitored in more detail, e.g., using specified patterns and/or gating parameters (196). It is noted that virtual fences 195 may be defined at any one or multiple ranges with respect to system 100 and cover any angular range (full circumference to narrow angle), possibly depending on the specific ranges and possibly dynamically modified, particularly in case of autonomous vehicle applications. Clearly, when system 100 is employed from a moving vehicle, continuous spatial updating of the locations of virtual fences 195 is carried out according to the changing geometry of scene 90 as perceived from the moving vehicle.

Object detection may be carried out according to shape parameters, reflectivity parameters or any other object defining parameters. In certain embodiments, processing unit 130 may be configured to detect moving objects in scene 90, e.g., according to changes in the reflected patterns and/or according to changes in the depth range data related to the objects.

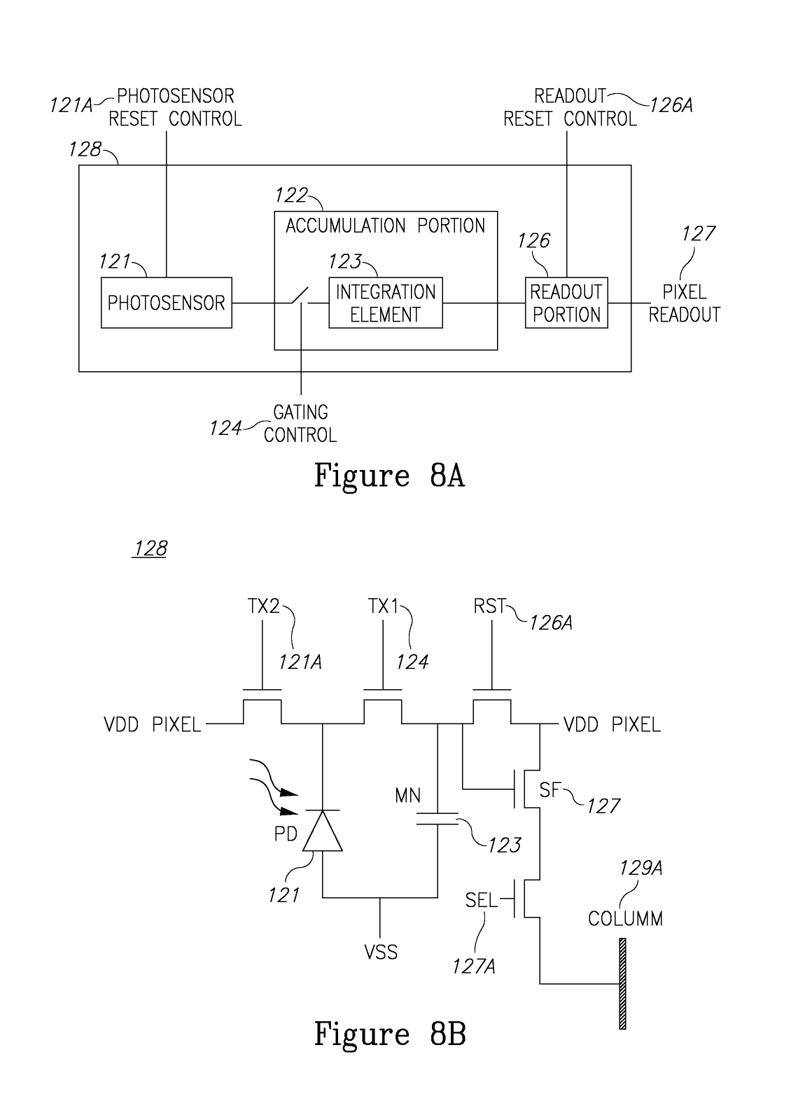

FIGS. 8A and 8B are high level schematic illustrations of detector 120, according to some embodiments of the invention.

FIG. 8A schematically illustrates conceptual configurations of detector pixels 128, comprising a photosensor 121 connected via a gating control 124 to an integration element, both latter elements being with an accumulation portion 122. The accumulated signal is then delivered to a readout portion 126 which provides the pixel readout. Photosensor 121, accumulation portion 122 and readout portion 126 may be reset by corresponding controls 121A and 126A.

Photosensor 121 outputs a signal indicative of an intensity of incident light. Photosensor 121 is reset by inputting the appropriate photosensor reset control signal. Photosensor 121 may be one of the following types: photodiodes, photogates, metal-oxide semiconductor (MOS) capacitors, positive-intrinsic-negative (PIN) photodiodes, a pinned photodiodes, avalanche photodiodes or any other suitable photosensitive element. Some types of photosensors may require changes in the pixel structure.

Accumulation portion 122 performs gated accumulation of the photosensor output signal over a sequence of time intervals. The accumulated output level may be reset by inputting a pixel reset signal into accumulation portion 122 (not illustrated). The timing of the accumulation time intervals is controlled by a gating control signal, as described below.

FIG. 8B schematically illustrates a “gate-able” pixel schematic 128 that may be provided by Complementary Metal Oxide Semiconductor (CMOS) standard fabrication technology, according to some embodiments of the invention. FIG. 8B is a non-limiting example for the design illustrated in FIG. 8A. Each pulse of light (i.e., each gate) is converted to a proportional electrical signal by the Photo-Diode (PD) 121 that may be a pinned PD 121 (as an example for photosensor 121 in FIG. 8A). The generated electrical signal from the PD is transferred by an electric field to the Floating Diffusion (FD)/Memory Node (MN) 123 which acts as an integrator 122 (i.e., a capacitor) accumulating each converted pulse of light (as an example for accumulation portion 122 in FIG. 8A). Two controllable pixel signals generate the pixel gate—the transfer gate transistor (TX1) 124 (as an example for gating control 124 in FIG. 8A) and the anti-blooming transistor (TX2) 121A (as an example for reset control 121A in FIG. 8A). The anti-blooming transistor has three main objectives; the first being part of the single light pulse gating mechanism when coupled to TX1 (i.e., TX2 is turned from ON to OFF or TX2 is turned from OFF to ON), the second preventing undesired parasitic signal generated in the PD not to be accumulated in the PD during the time TX1 is OFF (i.e., PD Reset) and the third to channel excessive electrical signal originated in the PD when TX1 is ON, hence the role of anti-blooming Anti-blooming TX2 controllable signal acts as an optical shutter which ends the single accumulated light pulse. Transfer gate transistor (TX1 124) is turned ON only in a desired time and only for a desired duration which is coupled to TX2 121A. Once all pulses of light were accumulated in the FD/MN 123, the signal is readout to provide a single image frame.

Multiple gated low noise pixels may have a standard electric signal chain after the “gate-able” configuration of PD 121, TX1 124, TX2 121A and FD/MN 123. This standard electric signal chain may consist of a Reset transistor (RST) 126A (as an example for readout reset control 126A in FIG. 8A) with the role of charging FD/MN 123 with electrical charge using the pixel voltage (VDD) or other voltage span, may consist of a Source Follower (SF) transistor 127 converting the accumulated signal (i.e., electrons) to voltage and may consist of a Select (SEL) transistor 127A connected to the column and/or row 129A for a pixel array.

This schematic circuit diagram depicting a “gate-able” pixel has a minimal of five transistors (“5T”). This pixel configuration may operate in a “gate-able” timing sequence. In addition this pixel may also operate in a standard 5T pixel timing sequence (such as Global Shutter pixel) or operate in a standard 4T pixel timing sequence. This versatile operating configuration (i.e., gating sequence or standard 5T or standard 4T) enables to operate the pixel under different lighting conditions. For example, gating timing sequence during low light level in active gated mode (with gated illumination), 4T timing sequence during low light level during nighttime (without illumination) and 5T timing sequence during high light level during daytime. This schematic circuit diagram depicting a “gate-able” pixel may also have additional circuits for internal Correlated Double Sampling (CDS) and/or for High Dynamic Range (HDR). Adding such additional circuits reduces the photo-sensing fill factor (i.e., sensitivity of the pixel). Pixel 128 may be fabricated with a standard epitaxial layer (e.g., 5 μm, 12 μm) or higher epitaxial layer (e.g., larger than 12 μm). In addition, epitaxial layer may have a standard resistivity (e.g., a few ohms) or high resistivity (e.g., a few kilo-ohms)

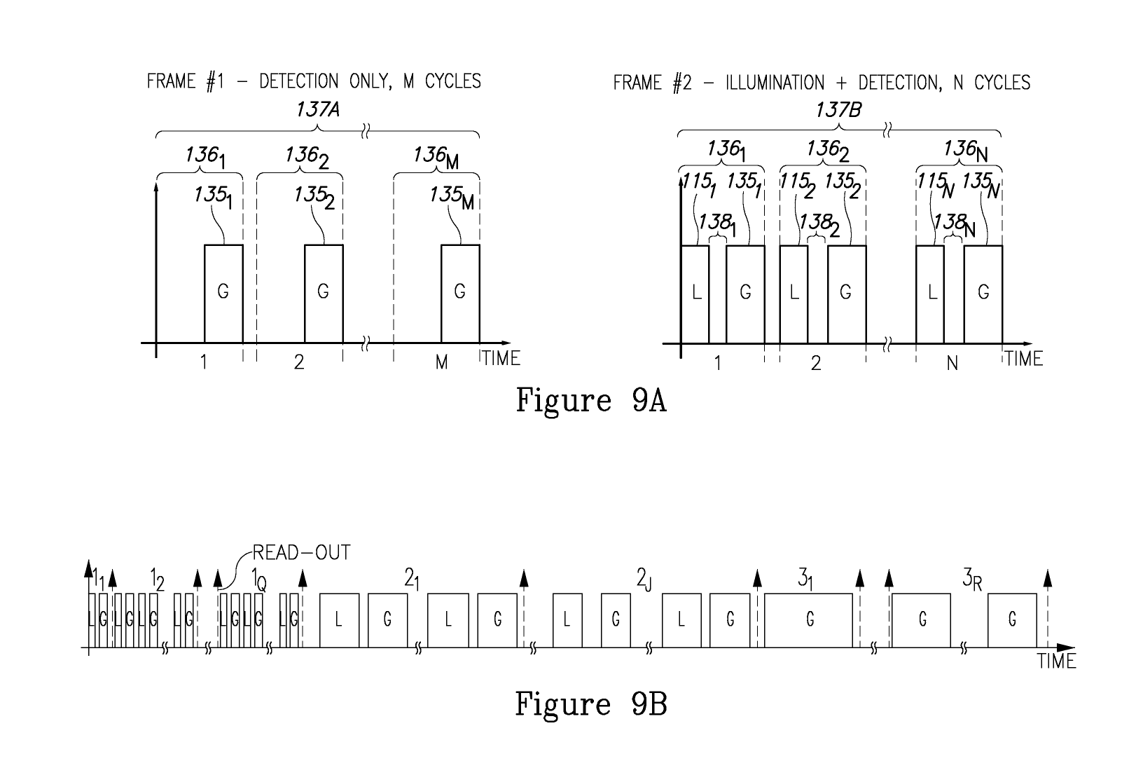

FIGS. 9A and 9B schematically illustrate related temporal sequences of illumination and detection, according to some embodiments of the invention. FIG. 9A schematically illustrates temporal sequences of illumination and detection, according to some embodiments of the invention. Gated detector 120 may have multiple gates (denoted by “G” for detector gating) with different length time exposures 135 marked 1, 2, . . . , M (i.e., 135₁, 135₂, . . . , 135_{M}) in different timing sequence 136 marked 1, 2, . . . , M (i.e., 136₁, 136₂, . . . , 136_{M}) per detector image frame 137A readout (image frame readout duration is not illustrated). Frame 137A may be used as a “passive” detection frame 137A (similar to image 125A in FIG. 6) in association with “active” detection frames 137B in which illuminator 110 applies illumination pulses. Active frame 137B may have a timing sequence: illumination pulse 115 followed by a certain delay 138 with a detector exposure 135 to implement gating. Illumination pulses 115 (denoted by “L” for laser) may have a different duration marked 1, 2, . . . , N (i.e., 115₁, 115₂, . . . , 115_{N}), each followed by a certain delay 138 marked 1, 2, . . . , N (i.e., 138₁, 138₂, . . . , 138_{N}) correlating to different T_{OFF} values. Detector 120 different exposure durations 135 marked 1, 2, . . . , N (i.e., 135₁, 135₂, . . . , 135_{N}) in different timing sequence 136 marked 1, 2, . . . , N (i.e., 136₁, 136₂, . . . , 136_{N}) up to N cycles per detector image frame 137B readout (image frame readout duration is not illustrated). Different length time exposures 135 and illumination pulses 115 duration correlating to different T_{LASER} and T_{II} values.

FIG. 9B schematically illustrates a generalized temporal sequence of illumination and detection, according to some embodiments of the invention. A specific pattern may comprise any number of elements from the generalized pattern illustrated in FIG. 9B. A first phase “1” may comprise one or more cycles 1₁, 1₂ . . . 1_{Q} of any number of pairs of illumination with one or more patterns 111 and gated detection, each cycle followed by a corresponding readout of the sensor. Illumination and detection periods may be short and/or relate to specific regions in the scene (e.g., directing specific patterns at specific regions). A second phase “2” may comprise one or more cycles 2₁, . . . 2₁ of any number of pairs of illumination (without patterns 111) and gated detection, each cycle followed by a corresponding readout of the sensor. Illumination and detection periods may be longer than in the first phase. Gating parameters may be at least partially determined with respect to readouts from the first phase. A third phase “3” may comprise one or more cycles 3₁, . . . 3_{R} of any number of detection (gated or not gated) without active illumination, each cycle followed by a corresponding readout of the sensor. Illumination and detection periods may be longer than in the second phase. Sensor (detector) 120 readout method may be different as describe herein below between types of frames (e.g., 1₁ . . . 1_{Q}, 2₁ . . . 2_{J} and 3₁ . . . 3_{R}).

In gated camera as detector 120, such as that based on a Gated CMOS Imager Sensor (“GCMOS”) and alike, gating (light accumulation) timing may be different from each pixel to another or from each array (several pixels or pixels cluster) to another in the GCMOS. The illustrated method enables each gated pixel (or gated array) to accumulate different DOF's (depth of focus “slices”, or depth ranges), accomplished by controlling each pixel or pixels cluster triggering mechanism. The illustrated gated imaging system may overcome the problems of imaging sensor blooming during high intensity ambient light level (e.g., during daytime, high or low front headlight of incoming vehicle during nighttime etc.) by short gates (i.e., exposure time\light accumulating) of the gated camera which are directly related to lowering the numbers of gates per image frame readout and/or narrowing the gates length time and/or lowering the gated camera gain. In certain embodiments, blooming may also be dealt with in the gated camera, such as GCMOS and alike, by a high anti-blooming ratio between each pixel to another (i.e., reducing signal diffusion overflow from pixel to neighboring pixel). For example, detector 120 may enable a dynamic range of 110 dB between frame to consecutive frame where the first frame has a single exposure of 50 nsec and the consecutive frame has a single exposure of 16 msec.

In order to exemplify the efficiency and sensitivity of proposed system 100 and method 200, the following calculation is presented. Assumptions:

### Detector Lens

Transmittance of optics T_{optics}=0.9; Target reflectivity r_{target}=0.3; Lens F-number F#=1.2, λ=808 nm. Lens diameter D=23 mm.

### Detector 120

GCMOS (gated complementary MOS—metal-oxide-semiconductor) sensor, pitch (pixel dimension) d=10 μm, Quantum efficiency QE=0.45, Sensitivity=QE·q_{electron}·λ/hc=0.293 A/W (ampere to watt). For a 1.2 Mpixel detector with Pixels_{horizontal}=1280, the instantaneous field of view IFOV=θ_{laser, h(horizontal)}/Pixels_{horizontal}=0.327 mrad.

### Illuminator 110

Laser peak power, Pₗₐₛₑᵣ=500 W, illuminator lens transmission τₗₐₛₑᵣ=0.9, θ_{laser, h(horizontal)}=24°, θ_{laser, v(vertical)}=8°, pulse length T_{g}=10 ns, Pulse shape factor η=0.99, dot divergence D_{dot,v(vertical)=}0.5°, D_{dot,h(horizontal)=}0.5°, thus Number of dots N_{dots}=θ_{laser, b}/D_{dot,h}·θ_{laser, v}/D_{dot,v}=768 with laser power per dot Pₛₚₒₜ=Pₗₐₛₑᵣ/N_{dots}=0.651 W.

### Atmospheric Conditions

Visibility Vis=12 km, height from sea level H=100 m.
Kh=0.96·exp(−(H/3)·0.132·10⁻³/ft)=0.946
Attenuation coefficient γ=−ln(0.02)/Vis·(λ/0.55μ)^{-1.3}·Kh=0.187 km⁻¹

### Typical Signal Per Pixel

Measured as the number of electrons reflected and received at the pixel per laser pulse (i.e., per gate signal), and calculated as: Electrons per gate=Sensitivity·Pₛₚₒₜ·τₗₐₛₑᵣ·(T_{optics}·r_{target}·e^{-2γR}/4 R²)·ƒ·T_{g}·D²/q_{electron}=(at R=150 m) 11 electrons.

### Typical Noise

Typical noise from solar radiation (daytime) at the respective wavelength, for solar irradiance Isun=800 W/m²μ at filtered wavelength Filter=30∥, calculated as: Electronsₛᵤₙ per gate=sensitivity·(Iₛᵤₙ·τₗₐₛₑᵣ·Filter/π)·(T_{optics}·r_{target}/4 F#²)·η·T_{g}·d²/q_{electron}=0.6 electrons.
Hence, the captured signal is significantly larger than the background noise.

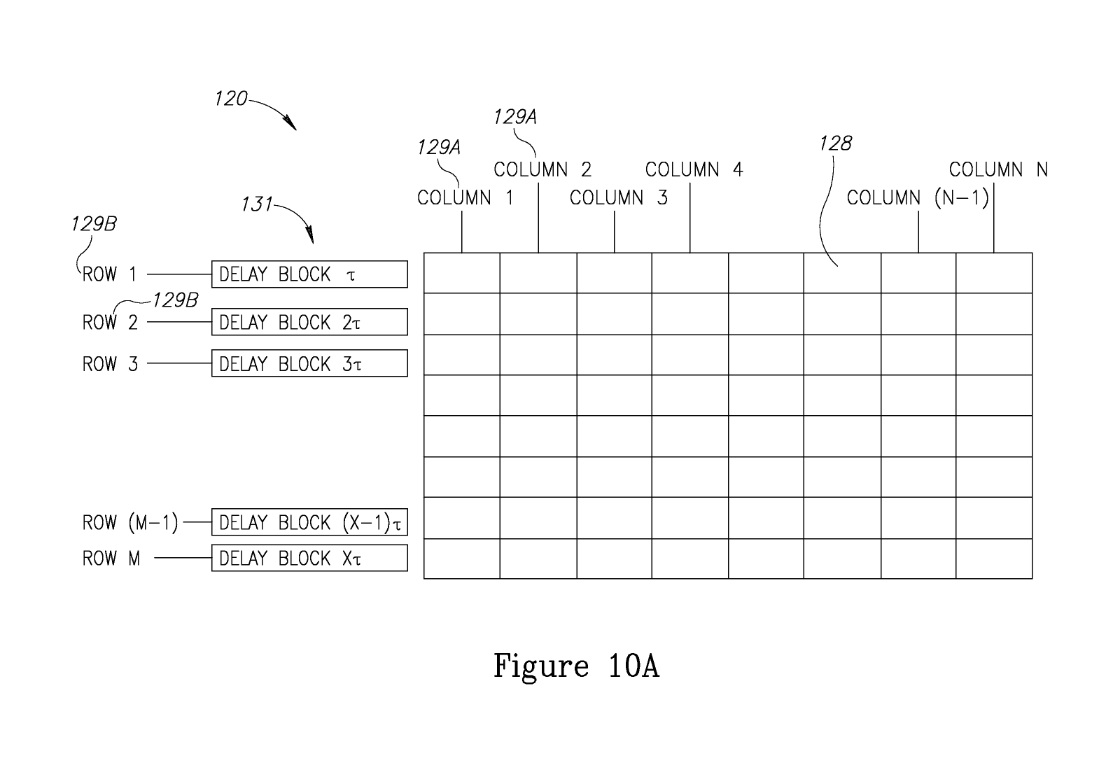

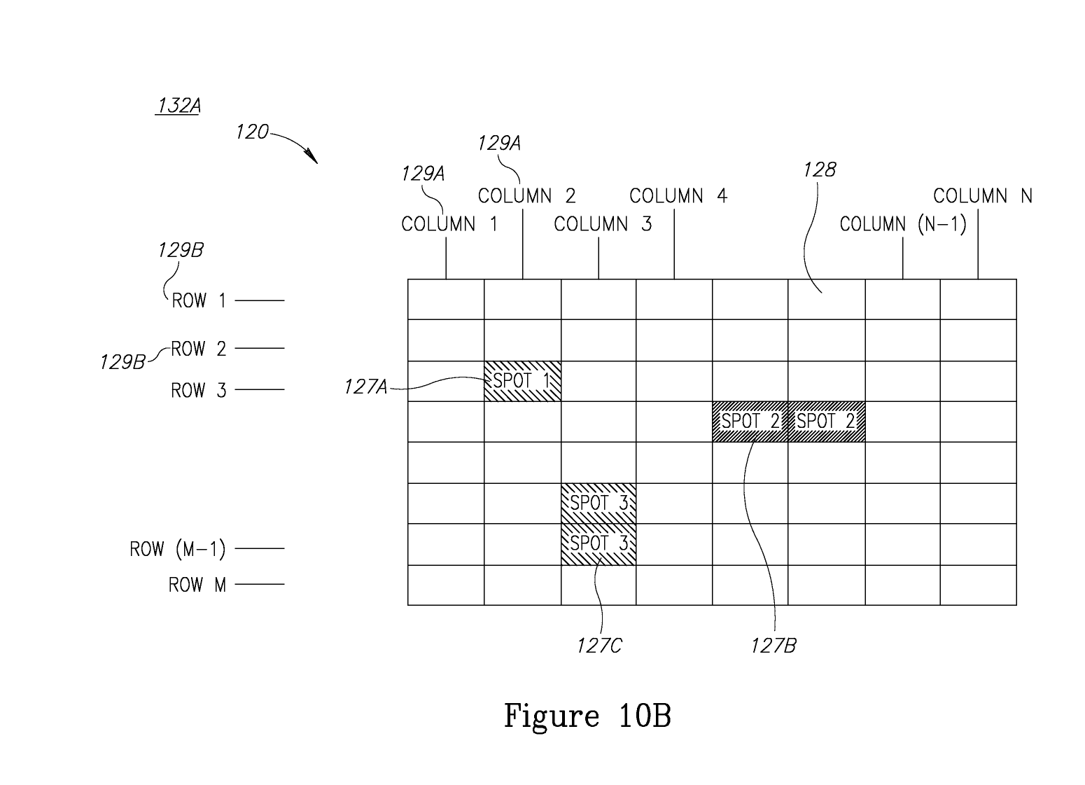

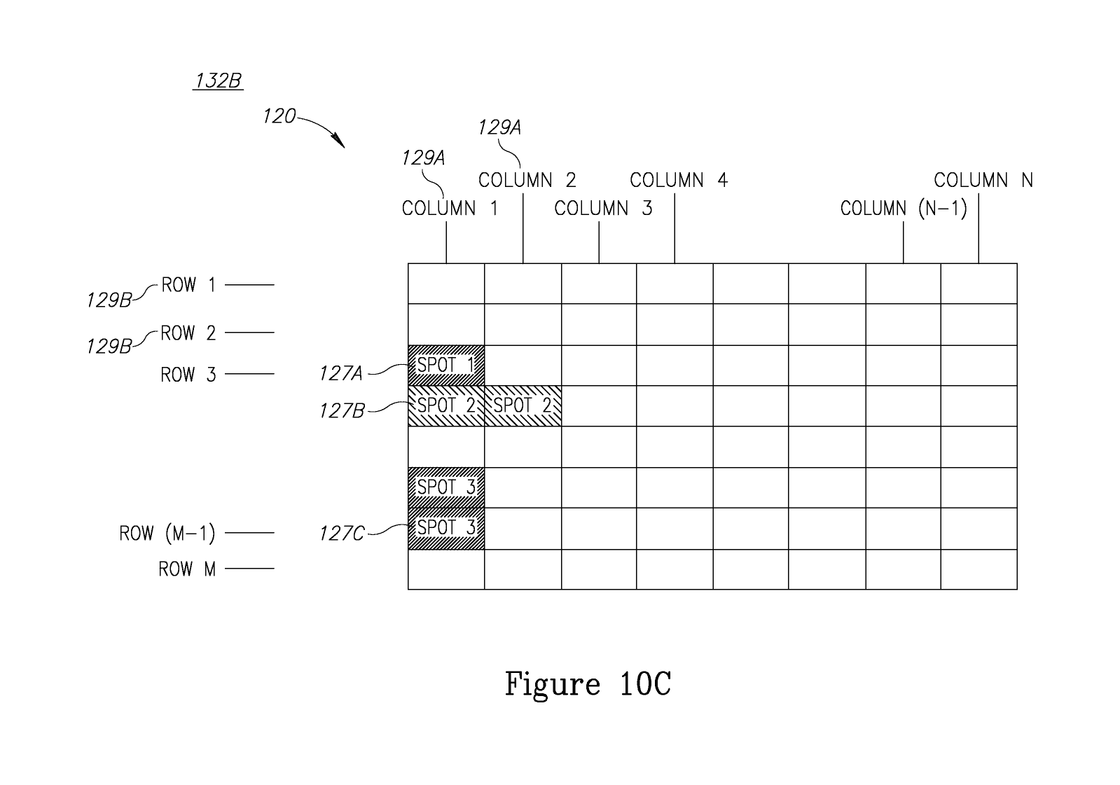

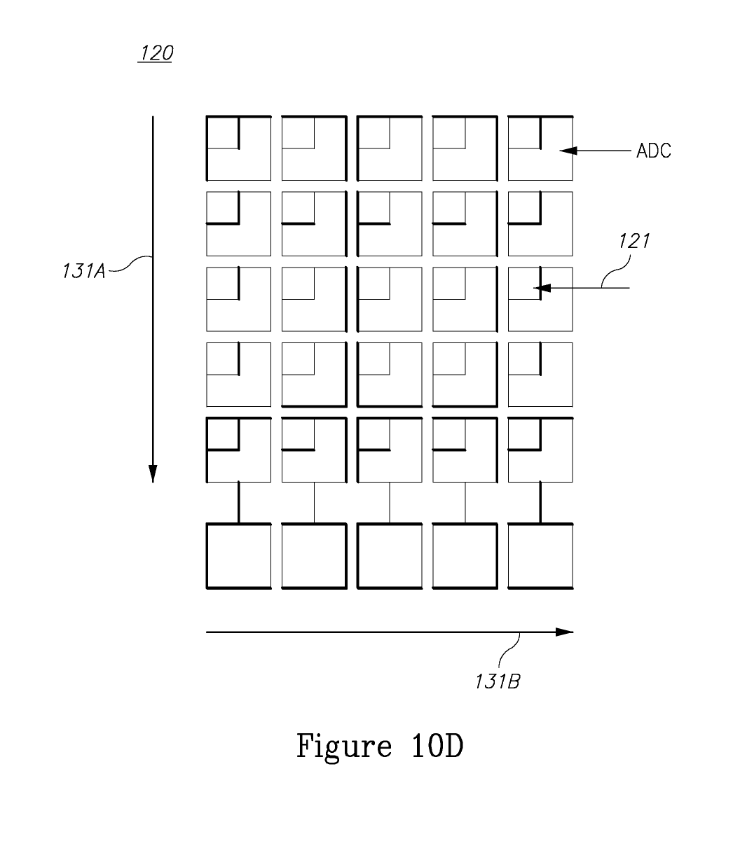

FIGS. 10A-10D schematically illustrate the pixel array of detector 120, according to some embodiments of the invention. In certain embodiments, pixel array 120 comprises N columns 129A and M rows 129B of pixels 128, and is commonly read row-wise. In certain embodiments, incremental, controllable delays 131 may be introduced between rows, (x−l)τ delay for the x^{th} row 129B (FIG. 10A). Incremental delays 131 may be introduced for row groups under any grouping (e.g., adjacent rows having the same delay, alternating rows having the same delay, or the same delay repeating every specified number of rows, as non-limiting examples). Controllable delays 131 may be implemented by a capacitor or by any other delay means to delay the triggering propagation signal of the detector rows. This delay provides a different T_{OFF} between the detector rows. After the exposure(s), the readout process is performed.

In certain embodiments, a readout process is provided in detector 120 of FIGS. 10B-10C. In stage 132A, certain pixels 128 may form clusters 127A, 127B and 127C per a single image-frame. For example, the clusters may correspond to reflections of illuminated pattern 111 and/or to reflections from a specified depth range defined by the gating timing In certain embodiments, pixels 128 and/or clusters 127A, 127B, 127C may be directly addressable and readout. In a second stage 132B of the readout process (FIG. 10C), pixels 128 and/or clusters 127A, 127B and 127C may be collected by another block (not illustrated) where in only the relevant columns (with the pattern data) are transferred to next stage of the readout process to yield faster readout (e.g., not reading columns with no or negligible pixel signal). Stages 132A, 132B may be configured to provide a faster readout mechanism of the image sensor (for the pattern frame) to minimize the readout time and minimize the required bandwidth.

FIG. 10D schematically illustrates handling pixel array 120 by implementing readout in the relevant rows/columns 131A, 131B (using parallel ADC). Each pixel has ADC circuit so that it is able to make use of two dimensional nature of image signal. Therefore the processing is very fast. This architecture has the disadvantages of the low fill factor and high power dissipation while it provides a short readout time and fast readout.

In certain embodiments, a readout process may be provided in detector 120 for a fixed pattern distribution in the detector plane, which may be implemented in the following steps: Step 1) Setup—configuring the map locations in the detector array 120 wherein the pattern is reflected. Step 2) exposing the detector 120 array as describe above. Step 3) Readout image (or part of the image) of the locations in the detector array 120 wherein the pattern is reflected by using the map locations. The readout process may be implemented by a “handshake” between the detector 120 to the processing unit 130 using the map location whereas a detector wishes to read a row it sends a message or any other flag to the processing unit 130 and the processing unit 130 replays if this row should be read (“Valid Row”). Whereas a row without any relevant data (i.e., no reflected pattern) may not be read, hence the processing unit 130 replays (“False Row”) and the detector skips this row to the next one. This proposed method reduces the number of rows to read and may have a faster framerate (versus reading the entire detector array) using a “standard” slow readout channel. For example—a detector having 1280×960 pixels, 10 bit, row readout of 4.25 us with a 4 LVDS data outputs, each running at 800 Mbps, plus 2 LVDS ports for clock recovery and image synchronization could provide a full image readout of 4.08 ms in the prior art. Advantageously, implementing the proposed method by reducing the readout rows may reach a full image readout time of only 0.85 ms (assuming 200 rows readout). Detector 120 pattern map locations may change per time or per type of pattern. Detector 120 may be configured to increase a readout frame rate by skipping empty detector rows.

In certain embodiments, a readout process is provided in detector 120 for a pattern distribution varying in the detector plane which may be implemented in the following steps: Step 1) exposing the detector 120 array as describe above. Step 2) Readout image (or part of the image) of the locations in the detector array 120 in which the pattern is reflected. The readout process may be implemented by using a row-summing detector block which provides a signal summing mechanism (or signal threshold) information. Once the signal exists in the row-summing detector block the row is valid whereas if the signal doesn't exist (no signal) in this block the row will not be readout. This proposed method reduces the amount of rows to read and may have a faster framerate (versus reading the entire detector array) using a prior art slow readout channel For example a detector having 1280×960 pixels, 10 bit, row readout of 4 us with a 4 LVDS data outputs, each running at 800 Mbps, plus 2 LVDS ports for clock recovery and image synchronization could provide full image readout of 3.84 ms in the prior art. Advantageously, implementing the proposed method by reducing the readout rows may reach a full image readout time of only 0.6 ms (assuming 150 rows readout). Detector 120 may be configured to increase a readout frame rate by addressing detector locations according to the illuminated specified spatial pattern.

In certain embodiments, a readout process that is provided in detector 120 may be implemented using any one of the following options: (i) using addressable pixels and/or pixel clusters, (ii) turning off or skipping columns that have no relevant data (implementing column-parallel ADC—analog to digital conversion), (iii) triggering from one side of the array (the “long part”) and reading-out in a rolling shutter mode (implementing Column-parallel ADC), (iv) having another block that organizes the array prior readout and (v) skipping rows that have no relevant data (implementing map locations or row-summing block).

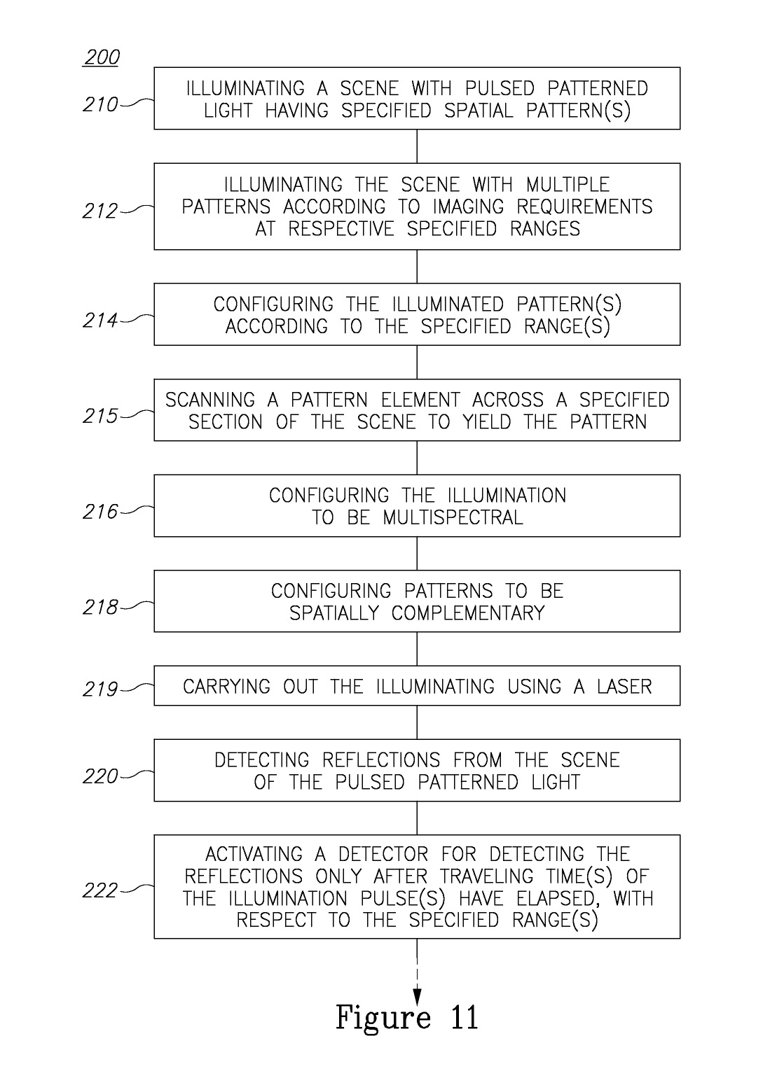

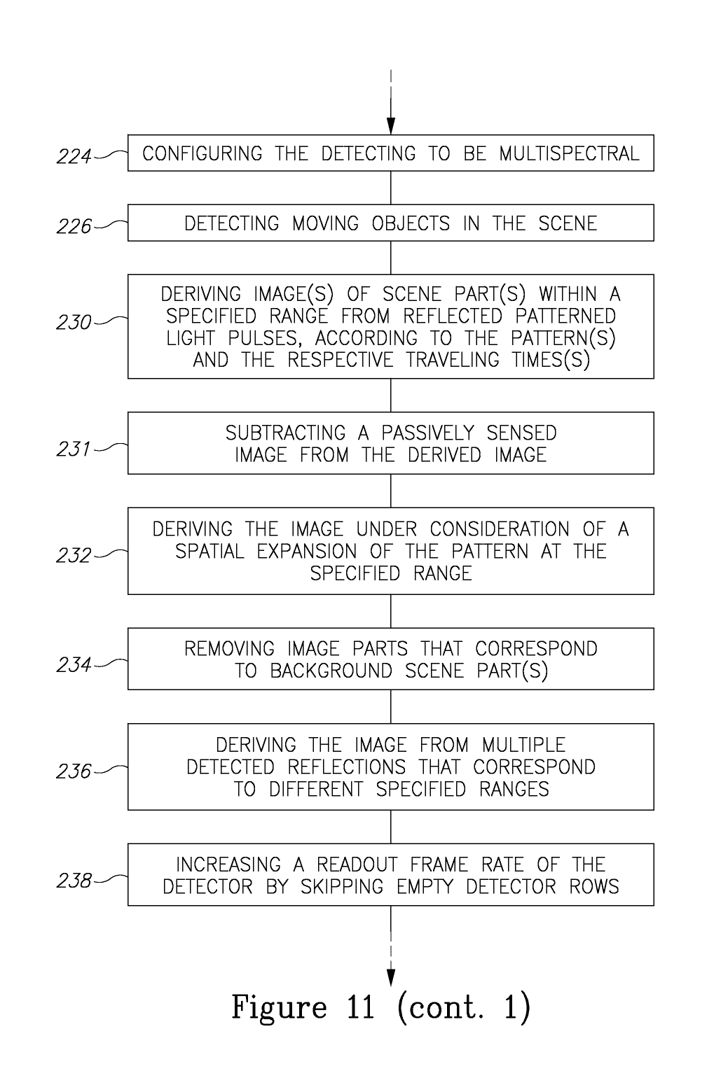

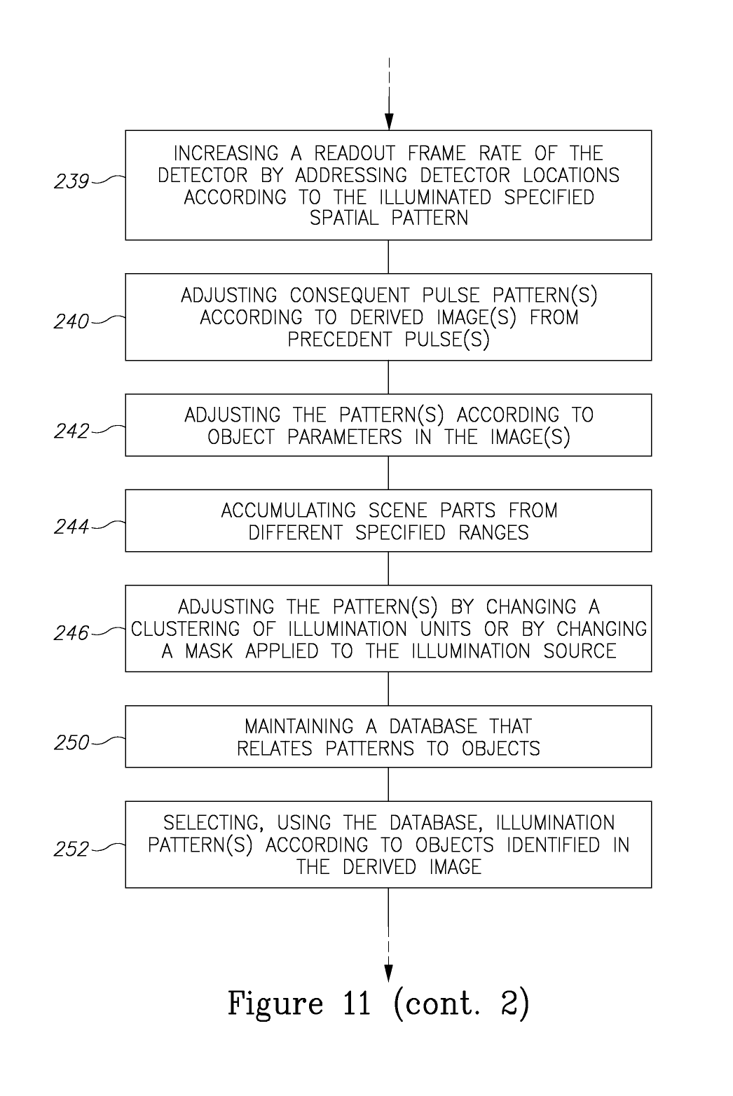

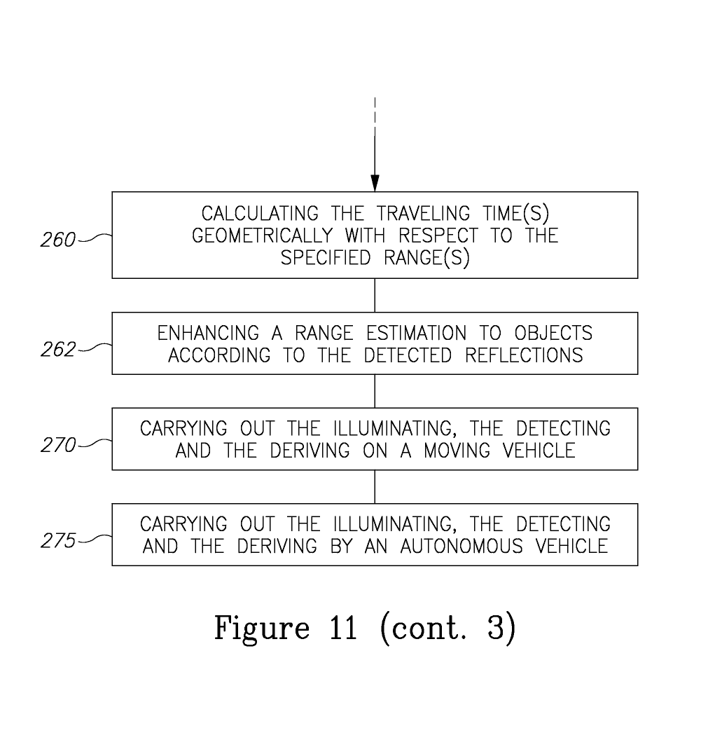

FIG. 11 is a high level flowchart illustrating a method 200, according to some embodiments of the invention. Method 200 may comprise illuminating a scene with pulsed patterned light having at least one specified spatial pattern (stage 210), detecting reflections of the pulsed patterned light from at least one specified range in the scene (stage 220), by activating a detector for detecting the reflections only after at least one traveling time of the respective illumination pulse, corresponding to the at least one specified range, has elapsed (stage 222), and deriving an image of at least a part of the scene within the at least one specified range, from the detected reflections and according to the at least one spatial pattern (stage 230).

Method 200 may further comprise illuminating the scene with a plurality of patterns, each pattern selected according to imaging requirements at respective specified ranges (stage 212). In certain embodiments, method 200 may further comprise configuring the illuminated pattern according to the specified range (stage 214). Method 200 may comprise configuring at least some of the patterns to be spatially complementary (stage 218). Illuminating the scene 110 and detecting the reflections 220 may be carried out by multispectral radiation (stages 216, 224). Method 200 may comprise carrying out the illuminating using a laser (stage 219).

In certain embodiments, illuminating the scene 210 may be carried out by scanning a pattern element across a specified section of the scene to yield the pattern (stage 215).

Method may further comprise detecting moving objects in the scene (stage 226), e.g., according to detected reflections of illumination patterns with respect to their respective depth ranges.

Method may further comprise subtracting a passively sensed image from the derived image (stage 231).

Method 200 may further comprise deriving the image under consideration of a spatial expansion of the pattern at the specified range (stage 232). Method 200 may comprise removing image parts corresponding to a background part of the scene, e.g., beyond a threshold range (stage 234). Method 200 may further comprise deriving the image from multiple detected reflections corresponding to different specified ranges (stage 236).

Method 200 may further comprise increasing a readout frame rate of the detector by skipping empty detector rows (stage 238) and/or by addressing detector locations according to the illuminated specified spatial pattern (stage 239).

In certain embodiments, method 200 further comprises adjusting at least one consequent pulse pattern according to the derived image from at least one precedent pulse (stage 240). Adjusting 240 may be carried out with respect to parameters of objects detected in the derived image (stage 242). For example, adjusting 240 may be carried out by changing a clustering of illumination units or by changing a mask applied to an illumination source (stage 246).

In certain embodiments, image derivation 230 may comprise accumulating scene parts having different specified ranges (stage 244).

Method 200 may further comprise maintaining a database that relates patterns to objects (stage 250) and selecting, using the database, illumination pattern(s) according to objects identified in the derived image (stage 252).

Method 200 may further comprise calculating the at least one traveling time geometrically with respect to the corresponding specified range (stage 260). In certain embodiments, method 200 may comprise enhancing range estimation(s) to object(s) according to the detected reflections (stage 262).

In certain embodiments, some of the steps of method 200, such as illuminating 210, detecting 220 and deriving 230, may be carried out on a moving vehicle (stage 270) and/or by an autonomous vehicle (stage 275).

FIGS. 12A-12D are high level schematic block diagrams of systems configurations, according to some embodiments of the invention. System 100 comprises illuminator 110 receiving power from vehicle 96 and converting the voltages and currents using a power supply 151 and communicated with processing unit 130 and/or detector 120. Power is used by a laser controller 152 and a laser wavelength controller 152 (as an option) and via a laser module 154 to generate illumination modified by a laser optical module 155. FIG. 12A schematically illustrates this basic configuration, while FIG. 12B schematically illustrates a configuration with a MEMS (microelectromechanical systems) device 156 (e.g., a DLP—a digital light processing device) for spatio-temporal control of illumination elements (e.g., pattern(s) and/or gating pulses). FIG. 12C schematically illustrates a configuration with two laser modules 155A, 155B fed from single laser module 154 via corresponding beam splitters 157A, 157B and configured to generate separately pattern(s) 111 and gating signals 150. FIG. 12D schematically illustrates a configuration with two laser modules 155A, 155B fed from two corresponding laser module 154A, 154B and configured to generate separately pattern(s) 111 and gating signals 150.

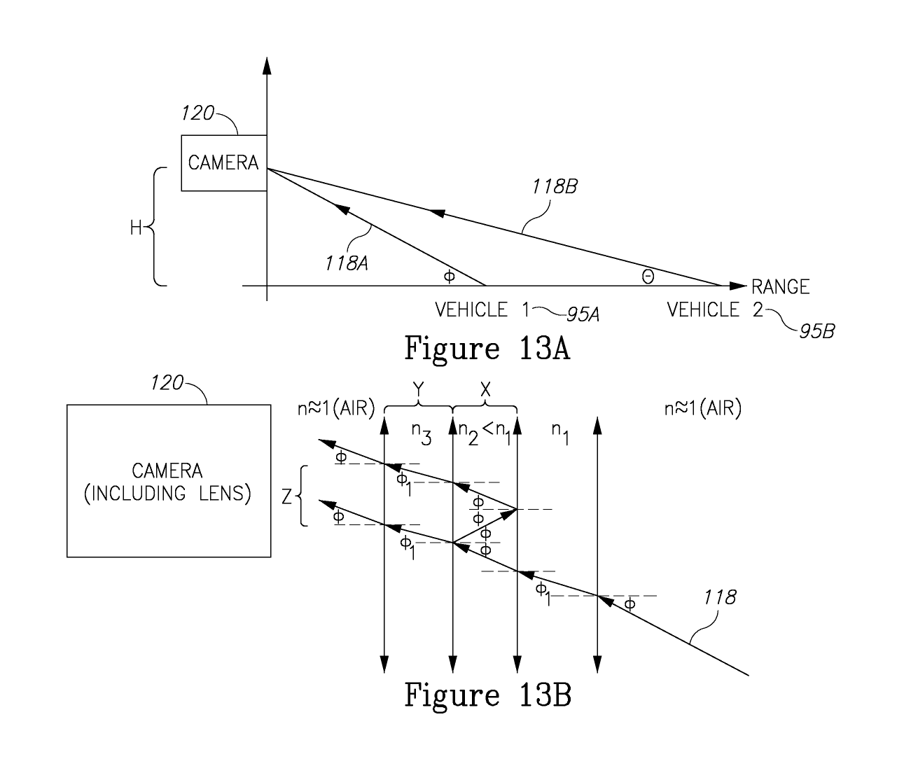

FIGS. 13A and 13B are high level schematic illustrations of measuring vehicle distances, according to some embodiments of the invention. FIG. 13A schematically illustrates the dependency between the range and a horizontal or height separation (H) resulting in different angles ϕ, θ from which illumination (reflections) 118A, 118B from different objects 95A, 95B (respectively) such as vehicles arrived at detector 120 such as a camera. FIG. 13B schematically illustrates a way to measure the angle ϕ of incoming illumination (reflections) 118 by measuring a distance Z between images of the object from which illumination (reflection) 118 is received. FIG. 13B demonstrates that, depending on the materials that separate detector 120 from the surroundings (e.g., a layered windshield), characterized by thicknesses X, Y and refractive indices n₁, n₂, n₃, angles ϕ result in proportional distances Z which may be used to measure or verify the value of ϕ.

Advantageously, with respect to WIPO Publication No. 2015/004213, in the current invention the detector is activated only after the traveling time of the respective illumination pulse has elapsed, while WIPO Publication No. 2015/004213 teaches synchronizing the detector with the illuminator, i.e., operating them simultaneously.

Advantageously, with respect to U.S. Patent Publication No. 20130222551, in the current invention a synergistic combination of gated imaging and structured light methods is achieved during the operation of the system to derive the captured images, while U.S. Patent Publication No. 20130222551 applies temporally modulated structured light during a calibration stage to derive depth information and spatiotemporal modulation during the capturing, but does not employ gated imaging to the modulated illumination and does not employ gated imaging synergistically with structured light illumination.

In the above description, an embodiment is an example or implementation of the invention. The various appearances of “one embodiment”, “an embodiment”, “certain embodiments” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone.

Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1-50. (canceled)

51. A method comprising:
illuminating a scene with pulsed patterned light, the illumination pulses having at least one specified spatial pattern,
detecting reflections of the illuminated pulsed patterned light from at least one specified range in the scene, by activating a detector for detecting the reflections only after at least one traveling time of the respective illumination pulse, corresponding to the at least one specified range, has elapsed; and for detecting the at least one specified spatial pattern of the reflections, and
deriving an image of at least a part of the scene within the at least one specified range, from the detected reflections and according to the detected at least one spatial pattern.

52. The method of claim 51, further comprising deriving the image under consideration of a spatial expansion of the pattern at the specified range.

53. The method of claim 51, further comprising illuminating the scene with a plurality of patterns, each pattern selected according to imaging requirements at respective specified ranges.

54. The method of claim 53, wherein at least some of the patterns are spatially complementary.

55. The method of claim 51, further comprising adjusting at least one consequent pulse pattern according to the derived image from at least one precedent pulse.

56. The method of claim 55, wherein the adjusting is carried out with respect to parameters of objects detected in the derived image.

57. The method of claim 55, wherein the adjusting is carried out by changing a clustering of illumination units or by changing a mask applied to an illumination source.

58. The method of claim 51, further comprising configuring the illuminated pattern according to the specified range.

59. The method of claim 58, further comprising enhancing range estimation according to the detected reflections.

60. The method of claim 51, further comprising removing image parts corresponding to a background part of the scene beyond a threshold range.

61. The method of claim 51, further comprising subtracting a passively sensed image from the derived image.

62. A system comprising:
an illuminator configured to illuminate a scene with pulsed patterned light, the illumination pulses having at least one specified spatial pattern,
a detector configured to detect reflections from the scene of the illuminated pulsed patterned light, and
a processing unit configured to derive an image of at least a part of the scene within at least one specified range, from detected reflected patterned light pulses having at least one traveling time that corresponds to the at least one specified range and according to the at least one spatial pattern, wherein the processing unit is further configured to control the detector and activate the detector for detecting the reflection only after the at least one traveling time has elapsed from the respective illumination pulse, and for detecting the at least one specified spatial pattern of the reflections.

63. A system comprising a gated imaging unit which employs gated structured light comprising patterned gated pulses, for illuminating a scene and a processing unit controlling the imaging unit and configured to correlate image data from depth ranges in the scene according to gating parameters with respective image parts derived from processing of reflected structured light patterns.

64. The system of claim 63, wherein the processing unit is further configured to analyze geometrical illumination pattern changes at different depth ranges.

65. The system of claim 63, wherein the processing unit is further configured to maintain specified illumination pattern characteristics at different depth ranges.

66. The system of claim 63, wherein the processing unit is further configured to match specified illumination patterns to specified depth ranges.

67. The system of claim 63, wherein the processing unit is further configured to analyze a 3D structure of the scene from the gated imaging and allocate specified illumination patterns to specified elements in the 3D structure.

68. The system of claim 63, wherein the processing unit is further configured to monitor virtual fences in the scene using the specified illumination patterns allocated to the specified elements in the 3D structure.

69. The system of claim 63, wherein the detector is configured to increase a readout frame rate by skipping empty detector rows and/or by addressing detector locations according to the illuminated specified spatial pattern.

70. A system comprising:
an illuminator configured to illuminate a scene with pulsed patterned light, the pulses having at least one specified spatial pattern,
a detector configured to detect reflections from the scene of the pulsed patterned light and detect the at least one specified spatial pattern of the reflections, and
a processing unit configured to derive three dimensional (3D) data of at least a part of the scene within a plurality of ranges, from detected reflected patterned light pulses having traveling times that correspond to the specified ranges and according to the detected at least one spatial pattern, wherein the processing unit is further configured to control the detector and activate the detector for detecting the reflection only after the corresponding traveling time has elapsed from the respective illumination pulse,
wherein the 3D data corresponds to data requirements of an autonomous vehicle on which the system is mounted.
